(19) United States
(12) Patent Application Publication
(10) Pub. No.: US 2010/0081024 A1
(43) Pub. Date: Apr. 1, 2010

(54) FUEL CELL SYSTEM

(75) Inventors: Takashi MATSUDA, Tokyo (JP); Yoshihisa Matsumoto, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/568,872

(22) Filed: Sep. 29, 2009

(30) Foreign Application Priority Data
Sep. 29, 2008 (JP) 2008-251674

(51) Int. Cl. H01M 8/04

(52) U.S. Cl. 429/24; 429/22; 429/25

(57) ABSTRACT

A fuel cell system including a secondary cell, a fuel cell power generation unit to carry out a power generation by an electrochemical reaction between a fuel and a water, a supply unit to supply the fuel and the water to the fuel cell power generation unit, a charging circuit to charge an electric energy generated in the fuel cell power generation unit to the secondary cell, an environmental level detection unit to detect an environmental level and a fuel cell control unit to control the supply unit based on the environmental level detected by the environmental level detection unit.

### CROSS-REFERENCE TO RELATED APPLICATIONS

This application is based upon and claims the benefit of priority under 35 USC 119 of Japanese Patent Application No. 2008-251674 filed on Sep. 29, 2008, the entire disclosure of which, including the description, claims, drawings, and abstract, is incorporated herein by reference in its entirety.

### BACKGROUND OF THE INVENTION

1. Field of the Invention

The present invention relates to a fuel cell system.

2. Description of the Related Art

Among fuel cells, there is a fuel cell which generates power by being continuously supplied with a mixture of methanol and water and there is a fuel cell which is provided with a micro reformer that generates hydrogen from methanol and water and which generates power by being continuously supplied with hydrogen. In any of the fuel cells, there is a need to pool methanol and water in a container such as a cartridge or a tank.

Further, for example, JP2002-134148 discloses that a secondary cell is provided in the fuel cell system and that electric power generated by the fuel cell power generation unit is accumulated in the secondary cell. For example, JP2002-134148 discloses a technique where power is charged to the secondary cell by the fuel cell power generation unit carrying out power generation when the charged amount of the secondary cell becomes less or equal to a certain level.

When environmental levels such as temperature, humidity and atmospheric pressure exceed the working limits of the fuel cell power generation unit, the fuel cell power generation unit may be damaged. For example, when the environmental temperature becomes below zero, the pooled water may freeze. In a case where the system is operated in a state where the environmental temperature is below zero, the high concentration methanol damages the reformer, the fuel cell and the like because only methanol in high concentration exceeding the operation range is to be supplied to the vaporizer, the reformer and the like. On the other hand, when the environmental temperature is high, the fuel may come to a boil. In such case, power cannot be generated because supplying amount of fuel becomes difficult to control in a case where the system is operated in a state where the fuel is boiling.

### BRIEF SUMMARY OF THE INVENTION

A fuel cell system comprises a secondary cell, a fuel cell power generation unit to carry out a power generation by an electrochemical reaction between a fuel and a water, a supply unit to supply the fuel and the water to the fuel cell power generation unit, a charging circuit to charge an electric energy generated in the fuel cell power generation unit to the secondary cell, an environmental level detection unit to detect an environmental level and a fuel cell control unit to control the supply unit based on the environmental level detected by the environmental level detection unit.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a schematic structure of a fuel cell system.

FIG. 2 is a block diagram showing a circuit structure of the fuel cell system.

FIG. 3 is a flow chart showing a flow of a process carried out by a control unit in the first embodiment.

FIG. 4 is a flow chart showing a flow of a process carried out by a fuel cell control unit.

FIG. 5 is a flow chart showing a flow of a process carried out by the fuel cell control unit.

FIG. 6 is a flow chart showing a flow of a process carried out by the fuel cell control unit.

FIG. 7 is a flow chart showing a flow of a process carried out by the fuel cell control unit.

FIG. 8 is a flow chart showing a flow of a process carried out by the fuel cell control unit.

FIG. 9 is a flow chart showing a flow of a process carried out by the fuel cell control unit.

FIG. 10 is a flow chart showing a flow of a process carried out by the fuel cell control unit.

FIG. 11 is a flow chart showing a flow of a process carried out by the fuel cell control unit.

### DETAILED DESCRIPTION OF THE INVENTION

Embodiments of the present invention will be explained with reference to the drawings.

### First Embodiment

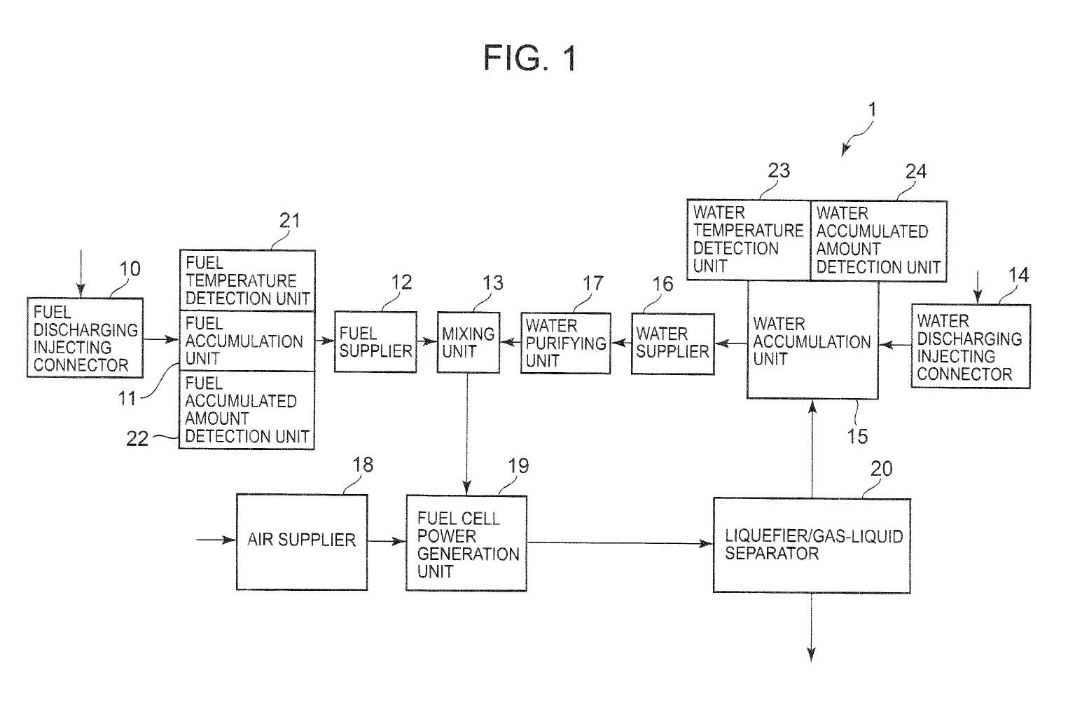

FIG. 1 is a block diagram showing a schematic structure of a fuel cell system 1.

The fuel cell system 1 is incorporated in a main body of an electronic device.

A fuel accumulation unit 11 is a container, and a liquid fuel is stored in the fuel accumulation unit 11. The liquid fuel stored in the fuel accumulation unit 11 may be pure fluid or may be a mixture of pure fuel and water. The type of the fuel may be methanol, ethanol or other fluid fuels. A fuel discharging injecting connector 10 is provided at the fuel accumulation unit 11, and fuel can be supplied and discharged through the fuel discharging injecting connector 10. Therefore, fuel in the fuel accumulation unit 11 is discharged outside through the fuel discharging injecting connector 10, and outside fuel is injected into the fuel accumulation unit 11 through the fuel discharging injecting connector 10.

At the fuel accumulation unit 11, a fuel temperature detection unit 21 and a fuel accumulated amount detection unit 22 are provided. The fuel temperature detection unit 21 detects a temperature of the fuel stored in the fuel accumulation unit 11 and converts the detected temperature into an electrical signal. The temperature detected by the fuel temperature detection unit 21 is outputted to the after-mentioned fuel cell control unit 31. The fuel accumulated amount detection unit 22 detects an accumulation amount of the fuel stored in the fuel accumulation unit 11 and converts the detected accumulation amount into an electrical signal. The accumulation amount detected by the fuel accumulated amount detection unit 22 is outputted to the fuel cell control unit 31.

A water accumulation unit 15 is a container, and water is stored in the water accumulation unit 15. Water to be stored in the water accumulation unit 15 may be pure water, water generated at the after-mentioned fuel cell power generation unit 19 or a water mixture thereof. Water discharging injecting connector 14 is provided at the water accumulation unit 15, and water can be supplied and discharged through the water discharging injecting connector 14. Therefore, water in the water accumulation unit 15 is discharged outside through the water discharging injecting connector 14 and outside water is injected into the water accumulation unit 15 through the water discharging injecting connector 14.

At the water accumulation unit 15, a water temperature detection unit 23 and a water accumulated amount detection unit 24 are provided. The water temperature detection unit 23 detects a temperature of the water stored in the water accumulation unit 15 and converts the detected temperature into an electrical signal. The temperature detected by the water temperature detection unit 23 is outputted to the after-mentioned fuel cell control unit 31. The water accumulated amount detection unit 24 detects an accumulation amount of the water stored in the water accumulation unit 15 and converts the detected accumulation amount into an electrical signal. The accumulation amount detected by the water accumulated amount detection unit 24 is outputted to the fuel cell control unit 31.

A fuel supplier (supply unit) 12 is a pump or a valve which are electrically driven or a combination thereof. The fuel supplier 12 aspirates the fuel in the fuel accumulation unit 11 and sends out the fuel to the mixing unit 13.

A water supplier (supply unit) 16 is a pump or a valve which are electrically driven or a combination thereof. The water supplier 16 aspirates the water in the water accumulation unit 15 and sends out the water to the mixing unit 13.

A water purifying unit 17 is provided between the water supplier 16 and the mixing unit 13. The water purifier unit 17 purifies the water to be sent to the mixing unit 13. For example, the water purifier unit 17 is a filter, and foreign substances included in the water which passes through the water purifier unit 17 are captured by the water purifier unit 17.

The mixing unit (supplier) 13 mixes the fuel sent from the fuel supplier 12 and the water sent from the water supplier 16. The liquid which is mixed at the mixing unit 13 is sent out to the fuel cell power generation unit 19.

An air supplier 18 is a device such as an air pump, a fan or the others for sending air. The air supplier 18 supplies outside air to the fuel cell power generation unit 19.

The fuel cell power generation unit 19 comprises a vaporizer, a reformer, a carbon monoxide remover, a fuel cell, various types of sensors, a heater, a valve and the like. The fuel cell power generation unit 19 carries out power generation by the liquid mixture of fuel and water sent from the mixing unit 13. That is, when the liquid mixture of fuel and water is continuously sent to the vaporizer by the mixing unit 13 and when outside air is continuously sent to the carbon monoxide remover and to the cathode of the fuel cell by the air supplier 18, the fuel cell power generation unit 19 continuously carries out the power generation at the fuel cell. In particular, first, fuel and water are heated and vaporized at the vaporizer. Next, the vaporized fuel and water are reformed into a reformed gas (including hydrogen, carbon dioxide, carbon monoxide and the like) by the reformer. Thereafter, a small amount of carbon monoxide generated in the reformer is removed by the carbon monoxide remover by the oxidation reaction with oxygen in the air which is sent from outside. Next, the hydrogen in the reformed gas which is sent to the anode of the fuel cell and the oxygen in the air sent to the cathode of the fuel cell react electrochemically with one another via the electrolyte film of the fuel cell. Then, the power generation occurs at the fuel cell by the electrochemical reaction between the hydrogen and oxygen in the fuel cell and further, moisture is generated. The moisture generated in the fuel cell is sent to the liquefier/gas-liquid separator 20 along with other products. In a case where the fuel cell of the fuel cell power generation unit 19 is a fuel cell having a solid high polymer electrolyte film, the fuel cell power generation unit 19 is structured as described above.

On the other hand, in a case where the fuel cell of the fuel cell power generation unit 19 carries out the power generation by methanol, the fuel cell power generation unit 19 does not comprise the reformer and the carbon monoxide remover and the fuel cell power generation unit 19 is structured with the vaporizer, the fuel cell and the like. In such case, first, the liquid mixture sent from the mixing unit 13 is sent to the vaporizer and the fuel and water are mixed and vaporized in the vaporizer. Next, the electric energy is taken out by the electrochemical reaction occurring between the vaporized fuel and water and oxygen in the air in the fuel cell, and also the gas including gaseous water (moisture) is sent to the liquefier/gas-liquid separator 20 from the fuel cell power generation unit 19. Here, in a case of a fuel cell which carries out the power generation by liquid methanol and water, the vaporizer can be further omitted.

Further, in a case where the fuel cell of the fuel cell power generation unit 19 is a fuel cell having the solid oxidized electrolyte film, the fuel cell power generation unit 19 does not comprise the carbon monoxide remover and the fuel cell power generation unit 19 is structured with the reformer, the vaporizer, the fuel cell and the like. In such case, first, the fuel and water are heated and vaporized in the vaporizer. Next, the vaporized fuel and water are reformed into a reformed gas by the reformer. Thereafter, hydrogen in the reformed gas which is sent to the anode of the fuel cell and oxygen in the air sent to the cathode of the fuel cell react electrically with one another via the electrolyte film of the fuel cell. Thereby, the power generation is carried out in the fuel cell, and moisture is further generated. The moisture generated in the fuel cell is sent to the liquefier/gas-liquid separator 20 along with other products.

Here, the vaporizer is embedded in the fuel cell power generation unit 19. However, the vaporizer may be provided separately from the fuel cell power generation unit 19, and the liquid mixture of fuel and water may be sent to the vaporizer by the mixing unit 13 so that the gas mixture which is vaporized in the vaporizer is supplied to the fuel cell power generation unit 19.

The liquefier/gas-liquid separator 20 comprises a liquefier, a gas-liquid separator and the like. In the liquefier/gas-liquid separator 20, the gas which is sent from the fuel cell power generation unit 19 is cooled by the liquefier and the moisture in the gas is condensed to liquid to be separated into liquid water and gas by the gas-liquid separator. The liquid water which is separated in the liquefier/gas-liquid separator 20 is sent to the water accumulation unit 15 to be accumulated in the water accumulation unit 15 and the separated gas is discharged outside as exhaust.

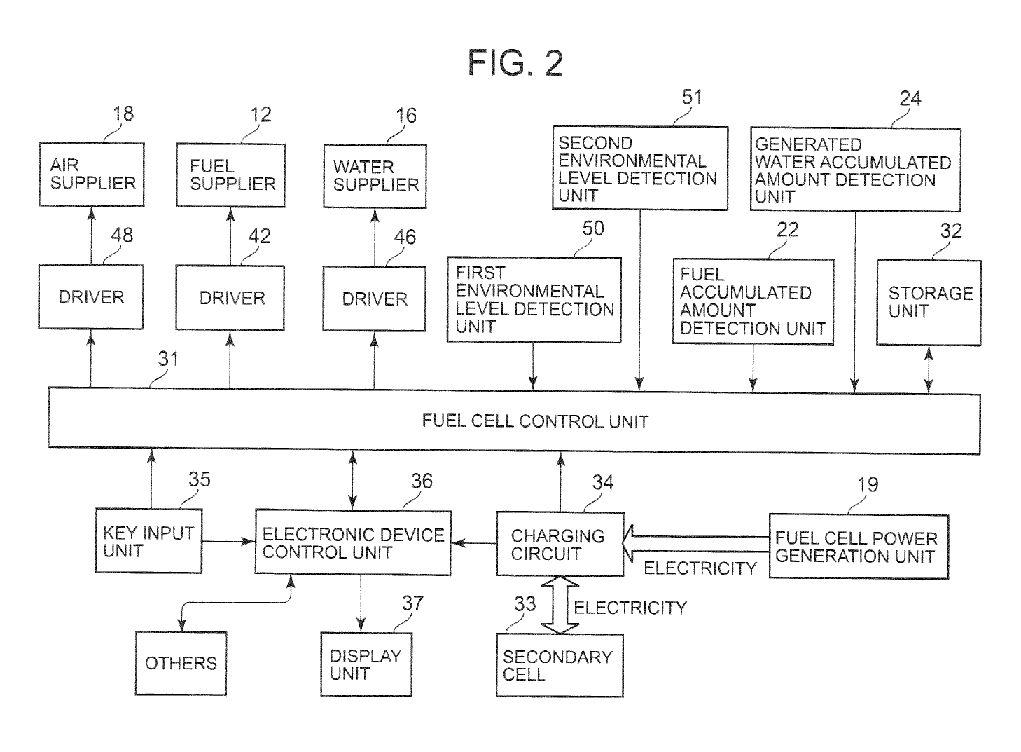

FIG. 2 is a block diagram showing a circuit structure embedded in a main body of an electronic device.

The fuel cell control unit 31 is a microcomputer having a CPU, a RAM and the like, for example. The fuel cell control unit 31 carries out a control of the fuel supplier 12, the water supplier 16, the air supplier 18 and the like.

The storage unit 32 is a non-volatile memory, a magnetic storage disc and other readable/writable storage medium, and various types of data are recorded in the storage unit 32. Here, reading and writing to the storage unit 32 is carried out by the fuel cell control unit 31.

A secondary cell 33 stores electric energy in a form of chemical energy.

In a case where power generation is carried out in the fuel cell of the fuel cell power generation unit 19, the charging circuit 34 supplies the electric energy generated in the fuel cell to the electronic device control unit 36 and the inner electrical parts of the electronic device (including a display unit 37, a key input unit 35, the storage unit 32 and other parts (for example, an image pickup device, a light-emitting device, date and time measuring circuit and the like)). Further, in a case where power generation is carried out in the fuel cell of the fuel cell power generation unit 19, the charging circuit 34 supplies and charges the electric energy generated in the fuel cell of the fuel cell power generation unit 19 excluding the electric energy supplied to the electronic device control unit 36 and to the inner electrical parts to the secondary cell 33. Further, in a case where power generation is not carried out in the fuel cell of the fuel cell power generation unit 19, the charging circuit 34 supplies the electric energy of the secondary cell 33 to the electronic device control unit 36 and to the inner electrical parts.

The key input unit 35 is constituted with various types of buttons, switches and the like, for example. The key input unit 35 outputs the input signal according to the operation of the buttons and switches to the fuel cell control unit 31 and to the electronic device control unit 36. Among various types of buttons, switches and the like of the key input unit 35, there is a power on/off switch.

The display unit 37 is a liquid crystal display, an electroluminescence display or other displays.

The electronic device control unit 36 is a microcomputer having a CPU, a RAM, a ROM and the like, for example. The electronic device control unit 36 carries out various types of processes based on the input signal inputted from the key input unit 35 and the signal inputted from the fuel cell control unit 31. For example, the electronic device control unit 36 outputs the display control signal to the display unit 37. In such way, a display according to the display control signal is carried out in the display unit 37. In a state where the electronic device control unit 36 is activated, the electronic device is in a state (operating state) where the device can exercise its function. In a state where the electronic device control unit 36 is in a stopped state, the electronic device is in a state (standby state) where the device does not exercise its function. For example, in the state where the electronic device control unit 36 is activated, the display unit 37 carries out the display operation. However, in the state where the electronic device control unit 36 is in a stopped state, the display unit 37 does not carry out the display operation. Here, even when the electronic device control unit 36 is in the stopped state, standby energy is supplied to the electronic device control unit 36 and to the inner electronic parts from the charging circuit 34.

The driver 42 amplifies the control signal of the fuel cell control unit 31 and outputs the amplified signal to the fuel supplier 12 to drive the fuel supplier 12.

The driver 46 amplifies the control signal of the fuel cell control unit 31 and outputs the amplified signal to the water supplier 16 to drive the water supplier 16.

The driver 48 amplifies the control signal of the fuel cell control unit 31 and outputs the amplified signal to the air supplier 18 to drive the air supplier 18.

The first environmental level detection unit 50 detects the environmental level of inside or at surrounding of the electronic device and converts the level into the electrical signal. The environmental level detected by the first environmental level detection unit 50 is outputted to the fuel cell control unit 31. Here, the environmental level is temperature, atmospheric pressure, humidity, brightness and other environmental physical quantities. For example, the first environmental level detection unit 50 is a temperature sensor, an atmospheric pressure sensor or a humidity sensor. The fuel temperature detection unit 21 or the water temperature detection unit 23 which are shown in FIG. 1 may be the first environmental level detection unit 50.

The second environmental level detection unit 51 detects the environmental level of inner or at surrounding of the electronic device and converts the detected level into the electrical signal. The target or the physical quantity to be detected by the second environmental level detection unit 51 is different from the target or the physical quantity to be detected by the first environmental level detection unit 50. For example, when the first environmental level detection unit 50 detects temperature as the environmental level, the second environmental level detection unit 52 detects atmospheric pressure as the environmental level.

Hereinafter, a flow of a process carried out by the fuel cell control unit 31, an operation of the electronic device and the like will be described.

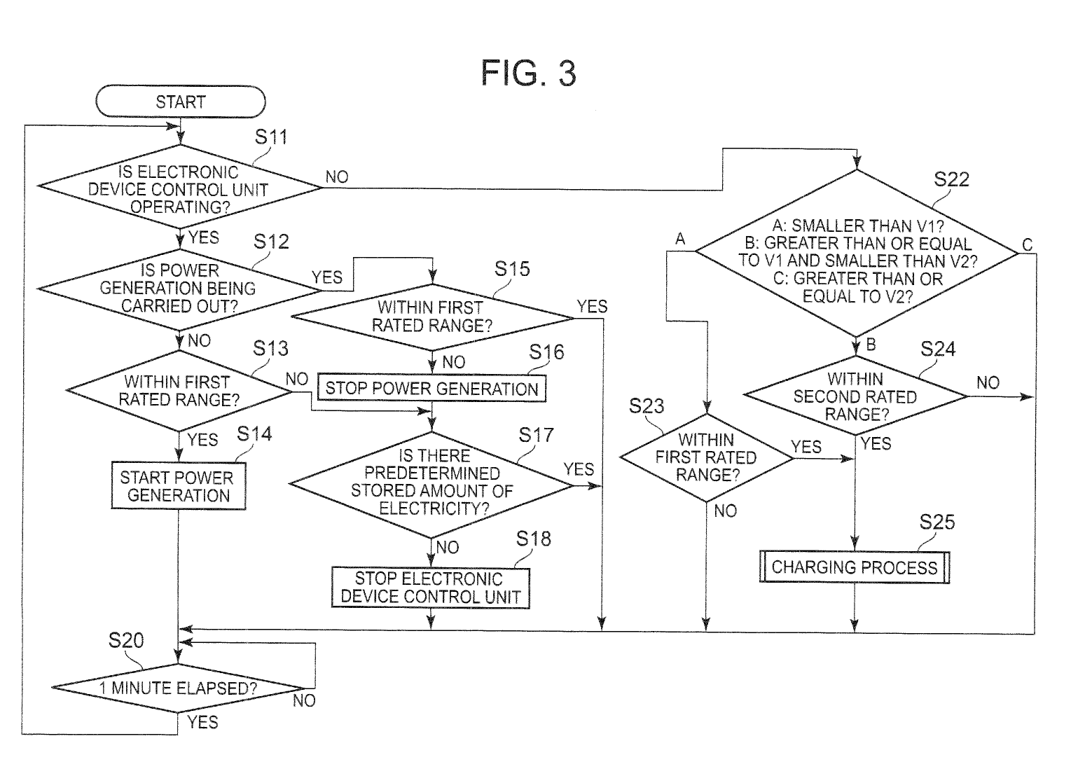

FIG. 3 is a diagram showing a flow of a process carried out by the fuel cell control unit 31. The fuel cell control unit 31 carries out the process shown in FIG. 3 regardless of whether the electronic device control unit 36 is activated or not.

As shown in FIG. 3, the fuel cell control unit 31 determines whether the electronic device control unit 36 is in an activated state or in a stopped state (step S11). When the electronic device control unit 36 is in a stopped state, a signal indicating that the electronic device control unit 36 is in a stopped state is inputted to the fuel cell control unit 31 from the electronic device control unit 36. Therefore, the process of the fuel cell control unit 31 moves to step S22 (step S11: No). Then, the fuel cell control unit 31 waits only for a predetermined time (for example, for a short period of time such as 1 minute) (step S20: No) after carrying out each process of steps S22 to 25. After the predetermined time has passed, the process of the fuel cell control unit 31 returns to step S11 (step S20: Yes). Each process of steps S22 to 25 are processes to be carried out when the electronic device is in a state where it cannot exercise its function (standby state), and the standby process will be described later in detail.

On the other hand, when the electronic device control unit 36 is in an activated state, a signal indicating that the electronic device control unit 36 is in an activated state is inputted to the fuel cell control unit 31 from the electronic device control unit 36. Therefore, the process of the fuel cell control unit 31 moves to step S12 (step S11: Yes).

In step S12, the fuel cell control unit 31 determines whether power generation is carried out in the fuel cell power generation unit 19 or not. In particular, the fuel cell control unit 31 determines whether the fuel supplier 12, the water supplier 16 or the air supplier 18 is driven or not (step S12). When the fuel supplier 12, the water supplier 16 or the air supplier 18 is stopped, power generation is not carried out in the fuel cell power generation unit 19. Therefore, the process of the fuel cell control unit 31 moves to step S13 (step S12: No). On the other hand, when the fuel supplier 12, the water supplier 16 and the air supplier 18 are operated, power generation is carried out in the fuel cell power generated unit 19. Therefore, the process of the fuel cell control unit 31 moves to step S15 (step S12: Yes).

In step S13, the fuel cell control unit 31 determines whether the environmental level detected by the first environmental level detection unit 50 is within the first rated range or not. In a case where the fuel temperature detection unit 21 or the water temperature detection unit 23 which are shown in FIG. 1 is the first environmental level detection unit 50, the fuel cell control unit 31 determines whether the temperature detected by the fuel temperature detection unit 21 or the temperature detected by the water temperature detection unit 23 is within the first rated range or not.

Here, the first rated rage is a range of the environmental level in which the fuel cell power generation unit 19 can be used. For example, when the environmental level is a temperature, it is preferred that the first rated range is set to the range between above 0° C. and below 60° C. This is because, 0° C. is the freezing pint of water, and when the temperature is 0° C. or below, the water in the water accumulation unit 15 freezes and the water cannot be supplied. Further, because 60° C. is near boiling point (64.7° C.) of the fuel and is below the boiling point of the fuel, and when the temperature is 60° C. or more, the fuel in the fuel accumulation unit 11 evaporates by the heat generated in the fuel cell power generation unit 19 and the liquid fuel cannot be supplied. In a case of such first rated range and when the fuel temperature detection unit 21 or the water temperature detection unit 23 is the environmental level detection unit 50, the fuel cell control unit 31 determines whether the temperature detected by the fuel temperature detection unit 21 is above 0° C. and below 60° C. or not, whether the temperature detected by the water temperature detection unit 23 is above 0° C. and below 60° C. or not or whether the temperature detected by the fuel temperature detection unit 21 is below 60° C. and the temperature detected by the water temperature detection unit 23 is above 0° C. or not.

Moreover, the upper limit value and the lower limit value of the first rated range may be variables or may be constant numbers. When the upper limit value and the lower limit value of the first rated range are variables, the fuel cell control unit 31 sets the upper limit value and the lower limit value of the first rated range according to a predetermined formula or a calculating table based on the environmental level detected by the second environmental level detection unit 51. For example, in a case where the first environmental level detection unit 50 is the temperature detection unit and where the second environmental level detection unit 51 is the atmospheric pressure sensor, the boiling point and the freezing point according to the atmospheric pressure can be respectively set as the upper limit value and the lower limit value of the first rated range. Here, when the upper limit value and the lower limit value of the first rated range are constant numbers, the constant numbers are set in the program to be used for the fuel cell control unit 31 in advance.

Further, the upper limit value of the first rated range maybe the boiling point of fuel. Furthermore, the upper limit value of the first rated range is a different value according to type of the fuel. For example, when ethanol is used for the fuel, the upper limit value of the first rated range may be set to 73° C. which is near boiling point (78° C.) of ethanol and which is a temperature lower than the boiling point of ethanol.

As a result of the fuel cell control unit 31 comparing the environmental level detected by the first environmental detection unit 50 to the upper limit value and the lower limit value of the first rated range, when the environmental level detected by the first environmental level detection unit 50 is within the first rated range (step S13: Yes), the process of the fuel cell control unit 31 moves to step S14. When the environmental level detected by the first environmental level detection unit 50 is not within the first rated range (step S13: No), the process of the fuel cell control unit 31 moves to step S17.

In step S14, the fuel cell control unit 31 drives the fuel supplier 12, the water supplier 16 and the air supplier 18. In such way, the fuel supplier 12, the water supplier 16 and the air supplier 18 are operated and power generation is carried out in the fuel cell power generation unit 19. Then, the electric energy generated in the fuel cell power generation unit 19 is supplied to the electronic device control unit 36 and to the inner electrical parts by the charging circuit 34, and the secondary cell 33 is charged by the excess electric energy excluding the electric energy supplied to the electronic device control unit 36 and the inner electrical parts. In such way, because the environmental level is within the first rated range, power generation can be carried out in the fuel cell power generation unit 19 without damaging the fuel cell power generation unit 19. For example, in a case where the environmental level is a temperature and where the first rated range is above 0° C. and below 60° C., the fuel in the fuel accumulation unit 11 does not vaporize and the water in the water accumulation unit 15 does not freeze. Therefore, the fuel cell power generation unit 19 is not damaged because the fuel in an accepted concentration is supplied to the fuel cell power generation unit 19. In addition, the secondary cell 33 can be charged because the power consumption of the electronic device control unit 36 and the inner electrical parts can be covered by the fuel cell power generation unit 19.

When the process of step S14 is finished, the fuel cell control unit 31 waits for a predetermined time (for example, for a short period of time such as 1 minute) (step S20: No) and the process of the fuel cell control unit 31 returns to step S11 when the predetermined time lapses (step S20: Yes). After returning to step S11, because the electronic device control unit 36 is operated and power generation is carried out in the fuel cell power generation unit 19, the process of the fuel cell control unit 31 moves to step S15 following step S12.

On the other hand, in step S17, the fuel cell control unit 31 detects the charged amount of the secondary cell 33 via the charging circuit 34 and determines whether the detected charged amount is more or equal to a predetermined value or not. In particular, the fuel cell control unit 31 detects the voltage between terminals of the secondary cell 33 by the charging circuit 34 and determines whether the detected voltage between terminals is more or equal to a predetermined threshold V1 [V] or not. Here, the predetermined threshold V1 is grater than the lower limit value VL [V] and smaller than the upper limit value VF [V]. The lower limit value VL is a voltage corresponding to the minimum charge amount needed in order to start power generation in the fuel cell power generation unit 19, and the upper limit value VF is a voltage corresponding to the charged amount charged only for the acceptable amount of the secondary cell 33.

When the charged amount of the secondary cell 33 is greater than or equal to a predetermined value (step S17: Yes), that is, when the voltage between terminals of the secondary cell 33 is greater than or equal to the predetermined threshold V1, the process of the fuel cell control unit 31 moves to step S20. Then, the fuel cell control unit 31 waits only for a predetermined time (for example, for a short period of time such as 1 minute) (step S20: No) and the process of the fuel cell control unit 31 returns to step S11 after the predetermined time elapses (step S20: Yes). Therefore, because the electronic device control unit 36 is operated and power generation is not carried out in the fuel cell power generation unit 19, the fuel cell control unit 31 repeats the processes of step S11, step S12, step S13, step S17 and step S20. When the environmental level detected by the first environmental detection unit 50 falls within the first rated range while the fuel cell control unit 31 repeating the above steps (step S13: Yes), the process of the fuel cell control unit 31 moves to step S14 from step S13. When the charged amount of the secondary cell 33 becomes smaller then the predetermined value while the fuel cell control unit 31 repeating the above steps (step S17: No), the process of the fuel cell control unit 31 moves to step S18 from step S17.

As described above, when the fuel cell control unit 31 is repeating the processes of step S11, step S12, step S13, step S17 and step S20, damage to the fuel cell power generation unit 19 due to the environmental level being outside the first rated range can be prevented by maintaining a state where the power generation is stopped in the fuel cell power generation unit 19. For example, when the environmental level is set to be temperature and when the first rated range is above 0° C. and below 60° C., damage to the fuel cell power generation unit 19 can be prevented because the fuel of unacceptable concentration will not be supplied to the fuel cell power generation unit 19 due to the fuel supplier 12 and the like being stopped because the fuel in the fuel accumulation unit 11 is vaporized and the water in the water accumulation unit 15 is frozen. Because the charged amount of the secondary cell 33 is acceptable charged amount, the electronic device control unit 36 and the inner electrical parts can be operated by the power of the secondary cell 33 even when power generation is not carried out in the fuel cell power generation unit 19.

When the charged amount of the secondary cell 33 is smaller than the predetermined value (step S17: No) in step S17, that is, when the voltage between terminals of the secondary cell 33 is smaller than the predetermined threshold V1, the process of the fuel cell control unit 31 moves to step S18. In step S18, the fuel cell control unit 31 stops the electronic device control unit 36. Then, the fuel cell control unit 31 waits for a predetermined time (for example, for a short period of time such as 1 minute) (step S20: No) and the process of the fuel cell control unit 31 returns to step S11 (step S20: Yes) after the predetermined time elapses. After returning to step S11, the fuel cell control unit 31 executes each process of step S22 to step S25 because the electronic device control unit 36 is stopped. In such way, when the charged amount of the secondary cell 33 becomes smaller than the predetermined value, discharge from the secondary cell 33 can be kept low because the power consumption of the electronic device control unit 36 and the inner electrical parts is reduced and only standby energy is needed. Also, the minimum charged amount needed in order to start power generation in the fuel cell power generation unit 19 is charged in the secondary cell 33.

Therefore, the fuel cell power generation unit 19 can be activated in each process of the following steps S22 to step S25 and the power generation can be started.

In step S15, the fuel cell control unit 31 determines whether the environmental level detected by the first environmental level detection unit 50 is within the first rated range or not. The determination process in step S15 is same as the determination process in step S13. Therefore, the detail description will be omitted.

As a result of the fuel cell control unit 31 comparing the environmental level detected by the first environmental level detection unit 50 to the upper limit value and lower limit value of the first rated range in step S15, when the environmental level detected by the first environmental level detection unit 50 is within the first rated range (step S15: Yes), the process of the fuel cell control unit 31 moves to step S20. Then, the fuel cell control unit 31 waits only for a predetermined time (for example, a short period of time such as 1 minute) (step S20: No) and the process of the fuel cell control unit 31 returns to step S11 after the predetermined time elapses (step S20: Yes). Therefore, the power generation in the fuel cell power generation unit 19 is continued.

On the other hand, when the environmental level detected by the first environmental level detection unit 50 is not within the first rated range (step S15: No), the fuel cell control unit 31 stops the fuel supplier 12, the water supplier 16 and the air supplier 18 (step S16).

Thereafter, the fuel cell control unit 31 determines whether the charged amount of the secondary cell 33 is greater than or equal to a predetermined value or not via the charging circuit 34. In particular, the fuel cell control unit 31 determines whether the voltage between terminals of the secondary cell 33 is greater than or equal to the predetermined threshold V1 [V] or not. When the charged amount of the secondary cell 33 is greater than or equal to a predetermined value according to the determination of the fuel cell control unit 31 (step S17: Yes), that is, when the voltage between terminals of the secondary cell 33 is greater than or equal to the predetermined threshold V1, the process of the fuel cell control unit 31 moves to step S20. Then, the fuel cell control unit 31 waits only for a predetermine time (for example, for a short period of time such as 1 minute) (step S20: No) and the process of the fuel cell control unit 31 returns to step S11 after the predetermined time elapses (step S20: Yes).

On the other hand, when the charged amount of the secondary cell 33 is smaller than the predetermined value according to the determination in step S17 (step S17: No), that is, when the voltage between terminals of secondary cell 33 is smaller than the predetermined threshold V1, the fuel cell control unit 31 stops the electronic device control unit 36 (step S18). Then, the fuel cell control unit 31 waits only for a predetermined time (for example, for a short period of time such as 1 minute) (step S20: No) and the process of the fuel cell control unit 31 returns to step S11 after the predetermined time elapses (step S20: Yes).

Next, each process of steps S22 to S25 will be described specifically.

First, the fuel cell control unit 31 detects the charged amount of the secondary cell 33 via the charging circuit 34 and compares the detected charged amount to the first predetermined value and to the second predetermined value (however, the second predetermined value is a value larger than the first predetermined value) (step S22). In particular, the fuel cell control unit 31 detects the voltage between terminals of the secondary cell 33 and determines whether the detected voltage between terminals is smaller than the predetermined threshold V1 (corresponding to the first predetermined, value) or not, whether the detected voltage between terminal is greater than or equal to the predetermined threshold V1 and smaller than the predetermined threshold V2 [V] (corresponding to the second predetermined value) or not and whether the detected voltage between terminals is greater than or equal to the predetermined threshold V2 or not. Here, relation between the predetermined threshold V1, the predetermined threshold V2, the lower limit value VL and the upper limit value VF is such that VL<V1<V2<VF.

As a result of the determination in step S22, when the charged amount of the secondary cell 33 is smaller than the first predetermined value, that is, when the voltage between terminals of the secondary cell 33 is smaller than the predetermined threshold V1 (step S22: A), the process of the fuel cell control unit 31 moves to step S23. Further, when the charged amount of the secondary cell 33 is greater than or equal to the first predetermined value and smaller than the second predetermined value (step S22: B), that is, when the voltage between terminals of the secondary cell 33 is greater than or equal to the predetermined threshold V1 and smaller than the predetermined threshold V2, the process of the fuel cell control unit 31 moves to step S24.

Further, when the charged amount of the secondary cell 33 is greater than or equal to the second predetermined value (step S22: C), that is, when the voltage between terminals of the secondary cell 33 is greater than or equal to the predetermined threshold V2, the process of the fuel cell control unit 31 moves to step S20. Then, the fuel cell control unit 31 waits only for a predetermined time (for example, for a short period of time such as 1 minute) (step S20: No) and the process of the fuel cell control unit 31 returns to step S11 after the predetermined time elapses (step S20: Yes).

In step S23, the fuel cell control unit 31 determines whether the environmental level detected by the first environmental level detection unit 50 is within the first rated range or not. The determination process of step S23 is same as the determination process of step S13. Therefore, the detail description will be omitted.

As a result of the fuel cell control unit 31 comparing the environmental level detected by the first environmental level detection unit 50 to the upper limit value and the lower limit value of the first rated range in step S23, when the environmental level detected by the first environmental level detection unit 50 is not within the first rated range (step S23: No), the process of the fuel cell control unit 31 moves to step S20. Then, the fuel cell control unit 31 waits only for a predetermined time (for example, for a short period of time such as 1 minute) (step S20: No) and the process of the fuel cell control unit 31 returns to step S11 after the predetermined time elapses (step S20: Yes).

On the other hand, when the environmental level detected by the first environmental level detection unit 50 is within the first rated range (step S23: Yes), the fuel cell control unit 31 carries out the charging process of step S25, and thereafter, the process of the fuel cell control unit 31 moves to step S20. Then, the fuel cell control unit 31 waits only for a predetermined time (for example, for a short period of time such as 1 minute) (step S20: No) and the process of the fuel cell control unit 31 returns to step S11 after the predetermined time elapses (step S20: Yes). The charging process of step S25 will be described in detail later.

In step S24, the fuel cell control unit 31 determines whether the environmental level detected by the first environmental level detection unit 50 is within the second rated range or not. When the fuel temperature detection unit 21 or the water temperature detection unit 23 which are shown in FIG. 1 is set to be the first environmental level detection unit 50, the fuel cell control unit 31 determines whether the temperature detected by the fuel temperature detection unit 21 or the temperature detected by the water temperature detection unit 23 is within the second rated range or not.

Here, only the specific numeric of the second rated range and the first rated range are different, and the second rated range is included in the first rated range. For example, in a case where the environmental level is set to be temperature, it is preferable that the range of above 0° C. to below 5° C. and the range of above 50° C. to below 60° C. are applied as the second rated range. First, when the range of temperature is above 0° C. to below 5° C., it is likely that the temperature becomes below 0° C. falling outside of the first rated range in near future. When the temperature is below 0° C., water in the water accumulation unit 15 freezes and there is a possibility that water cannot be supplied. Further, when the range of temperature is above 50° C. to below 60° C., it is likely that the temperature exceeds 60° C. falling outside of the first rated range in near future. When the temperature is greater than or equal to 50° C., the fuel in the fuel accumulation unit 11 vaporizes and there is a possibility that fuel cannot be supplied. As described above, when the environmental level falls within the second rated range, it is likely that the environmental level falls outside the first rated range in near future.

In a case where the second rated range is set as described above and where the fuel temperature detection unit 21 or the water temperature detection unit 23 is set to be the environmental level detection unit 50, the fuel cell control unit 31 determines whether the temperature detected by the fuel temperature detection unit 21 is within the range of above 0° C. to below 5° C. or within the range of above 50° C. to below 60° C. or not, whether the temperature detected by the water temperature detection unit 23 is within the range of above 0° C. to below 5° C. or within the range of above 50° C. to below 60° C. or not or whether the temperature detected by the fuel temperature detection unit 21 is within the range of above 50° C. to below 60° C. and the temperature detected by the water temperature detection unit 23 is within the range of above 0° C. and below 5° C. or not.

Further, the upper limit value and the lower limit value of the second rated range may be variables or may be constant numbers. When the upper limit value and the lower limit value of the second rated range is variables, the fuel cell control unit 31 sets the upper limit value and the lower limit value of the second rated range according to a predetermined formula or a calculating table based on the environmental level detected by the second environmental level detection unit 51. For example, in a case where the first environmental level detection unit 50 is set to be the temperature detection unit and where the second environmental level detection unit 51 is set to be the atmospheric pressure sensor, values near boiling point or freezing point according to the atmospheric pressure can be respectively set as the upper limit value and the lower limit value of the second rated range. Here, when the upper limit value and the lower limit value of the second rated range are constant numbers, the constant numbers are set in the program to be used for the fuel cell control unit 31’ in advance.

As a result of the fuel cell control unit 31 comparing the environmental level detected by the first environmental level detection unit 50 to the upper limit value and lower limit value of the second rated range, when the environmental level detected by the first environmental level detection unit 50 is within the second rated range (step S24: Yes), the fuel cell control unit 31 carries out the charging process of step S25, and thereafter, the process of the fuel cell control unit 31 moves to step S20 (see FIG. 3). Then, the fuel cell control unit 31 waits only for a predetermined time (for example, for a short period of time such as 1 minute) (step S20: No) and the process of the fuel cell control unit 31 returns to step S11 after the predetermined time elapses (step S20: Yes). The charging process of step S25 will be described in detail later.

On the other hand, in a case where the environmental level detected by the first environmental level detection unit 50 is not within the second rated range (step S24: No), the process of the fuel cell control unit 31 moves to step S20. Then, the fuel cell control unit 31 waits only for a predetermined time (for example, for a short period of time such as 1 minute) (step S20: No) and the process of the fuel cell control unit 31 returns to step S11 after the predetermined time elapses (step S20: Yes).

As described above by referring to FIG. 3, the process of step S23 or step S24 corresponds to the first determination process and the process of step S22 corresponds to the second determination process. Here, the first determination process is a process to determine whether the environmental level detected by the first environmental level detection unit 50 is within a rated range (the first rated range or the second rated range) or not. In the second determination process, the fuel cell control unit 31 detects the charged amount of the secondary cell 33 and determines whether to carry out the first determination process (process of step S23 or step S24) or not according to the detected charged amount. Then, as described above, as a result of the determination of step S22, when the detected charged amount of the secondary cell 33 is smaller than the second predetermined value, that is, when the voltage between terminals of the secondary cell 33 is smaller than the predetermine threshold V2, the fuel cell control unit 31 carries out the determination of step S23 or step S24. On the other hand, as a result of the determination of step S22, when the detected charged amount of the secondary cell 33 is greater than or equal to the second predetermined value, that is, when the voltage between terminals of the secondary cell 33 is greater than or equal to the predetermined threshold V2, the fuel cell control unit 31 carries out the determination of step S22 again after waiting a predetermine time (for example, a short period of time such as 1 minute).

Here, when the process of the fuel cell control unit 31 moves to the first determination process from the second determination process, the fuel cell control unit 31 sets the rated range to be used in the first determination process based on the detected charged amount of the secondary cell 33. When the charged amount of the secondary cell 33 is smaller than the first predetermined value, that is, when the voltage between terminals of the secondary cell 33 is smaller than the predetermined threshold V1, the fuel cell control unit 31 sets the rated range to the first rated range in step S23. Further, when the charged amount of the secondary cell 33 is greater than or equal to the first predetermined value and smaller than the second predetermined value, that is, when the voltage between terminals of the secondary cell 33 is greater than or equal to the predetermine threshold V1 and smaller than the predetermined threshold V2, the fuel cell control unit 31 sets the rated range to the second rated range in step S24.

Moreover, as for each process of step S22 to step S24, the order of the processes can be arbitrarily interchanged. Regardless of which order the processes is to be carried out, the fuel cell control unit 31 carries out the charging process of step S25 only when determining that the following condition is met, and thereafter, the process of the fuel cell control unit 31 moves to step S20.

That is, firstly, when the voltage between terminals of the secondary cell 33 is smaller than the predetermined threshold V1 in the second determination process of step S22 (step S22: A) and at the same time, when the environmental level detected by the first environmental level detection unit 50 is within the first rated range in the first determination process of step S23 (step S23: Yes), the charging process of the step S25 is carried out, and thereafter, the process of the fuel cell control unit 31 moves to step S20. Further, secondly, when the charged amount of the secondary cell 33 is greater than or equal to the first predetermined value and smaller than the second predetermined value (step S22: B) in the second determination process of step S22, and at the same time, when the environmental level detected by the second environmental level detection unit 50 is within the second rated range in the first determination process of step S24 (step S24: Yes), the charging process of step S25 is carried out, and thereafter, the process of the fuel cell control unit 31 moves to step S20.

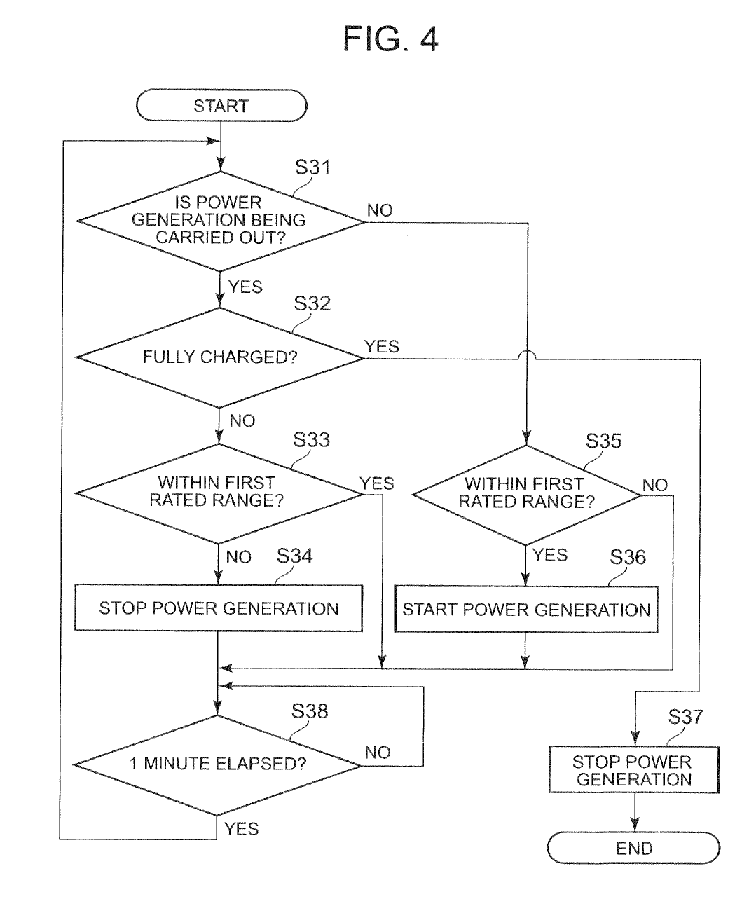

Next, the charging process of step S25 will be described specifically with reference to FIG. 4.

First, the fuel cell control unit 31 determines whether power generation is carried out in the fuel cell power generation unit 19 or not (step S31). In particular, the fuel cell control unit 31 determines whether the fuel supplier 12, the water supplier 16 or the air supplier 18 is driven or not. When the fuel supplier 12, the water supplier 16 or the air supplier 18 is stopped, power generation is not carried out in the fuel cell power generation unit 19. Therefore, the process of the fuel cell control unit 31 moves to step S35 (step S31: No). On the other hand, when the fuel supplier 12, the water supplier 16 and the air supplier 18 are operated, power generation is carried out in the fuel cell power generation unit 19. Therefore, the process of the fuel cell control unit 31 moves to step S32 (step S31: Yes).

In step S32, the fuel cell control unit 31 determines whether the charged amount of the secondary cell 33 is full or not via the charging circuit 34. In particular, the fuel cell control unit 31 determines whether the voltage between terminals of the secondary cell 33 is greater than or equal to the upper limit value VF [V] or not.

Then, when the fuel cell control unit 31 determines that the charged amount of the secondary cell 33 is full (step S32: Yes), the fuel cell control unit 31 stops the fuel supplier 12, the water supplier 16 and the air supplier 18 (step S37). Thereby, charging to the secondary cell 33 finishes in a state where the secondary cell 33 is maximally charged. Then, the process of the fuel cell control unit 31 moves to step S20 and then to step S11.

On the other hand, when the fuel cell control unit 31 determines that the charged amount of the secondary cell 33 is not full (step S32: No), the process of the fuel cell control unit 31 moves to step S33.

In step S33, the fuel cell control unit 31 determines whether the environment level detected by the first environment level detection unit 50 is within the first rated range or not. The determination process of step S33 is same as the determination process of step S13. Therefore, the detail description will be omitted.

As a result of the fuel cell control unit 31 comparing the environmental level detected by the first environmental level detection unit 50 to the upper limit value and lower limit value of the first rated range, when the environmental level detected by the first environmental level detection unit 50 is within the first rated range (step S33: Yes), the fuel cell control unit 31 waits only for a predetermined time (for example, for a short period of time such as 1 minute) (step S38: No) and the process of the fuel cell control unit 31 returns to step S31 after the predetermined time elapses (step S38: Yes). Thereby, the power generation in the fuel cell power generation unit 19 is continued and the charging to the secondary cell 33 is also continued.

On the other hand, when the environmental level detected by the first environmental level detection unit 50 is not within the first rated range (step S33: No), the fuel cell control unit 31 stops the fuel supplier 12, the water supplier 16 and the air supplier 18 (step S34). Then, the power generation in the fuel cell power generation unit 19 stops. Thereafter, the fuel cell control unit 31 waits only for a predetermined time (for example, for a short period of time such as 1 minute) (step S38: No) and the process of the fuel cell control unit 31 returns to step S31 after the predetermined time elapses (step S38: Yes). In such way, when the environmental level falls outside of the first rated range, fuel will not be supplied to the fuel cell power generation unit 19. Therefore, the fuel cell power generation unit 19 will not be damaged because fuel of unacceptable concentration will not be supplied to the fuel cell power generation unit 19.

In step S35, the fuel cell control unit 31 determines whether the environmental level detected by the first environmental detection unit 50 is within the first rated range or not. The determination process of step S35 is same as the determination process of step S13. Therefore, the detail description will be omitted.

As a result of the fuel cell control unit 31 comparing the environmental level detected by the first environmental level detection unit 50 to the upper limit value and lower limit value of the first rated range, when the environmental level detected by the first environmental level detection unit 50 is within the first rated range (step S35: Yes), the fuel cell control unit 31 operates the fuel supplier 12, the water supplier 16 and the air supplier 18. As a result, power generation is started in the fuel cell power generation unit 19. However, the fuel cell power generation unit 19 will not be damaged because fuel in acceptable concentration is supplied to the fuel cell power generation unit 19. Thereafter, the fuel cell control unit 31 waits only for a predetermined time (for example, for a short period of time such as 1 minute) (step S38: No) and the process of the fuel cell control unit 31 returns to step S31 after the predetermined time elapses (step S38: Yes).

On the other hand, when the environmental level detected by the first environmental level detection unit 50 is not within the first rated range (step S35: No), the fuel cell control unit 31 waits only for a predetermined time (for example, for a short period of time such as 1 minute) (step S38: No) and the process of the fuel cell control unit 31 returns to step S31 after the predetermined time elapses (step S38: Yes). Thereby, a state where power is not being generated in the fuel cell power generating unit 19 is continued.

As described above, the secondary cell 33 is charged by the charging process of step S25 (step S31 to step S38) being carried out, and the charged amount of the secondary cell 33 becomes full.

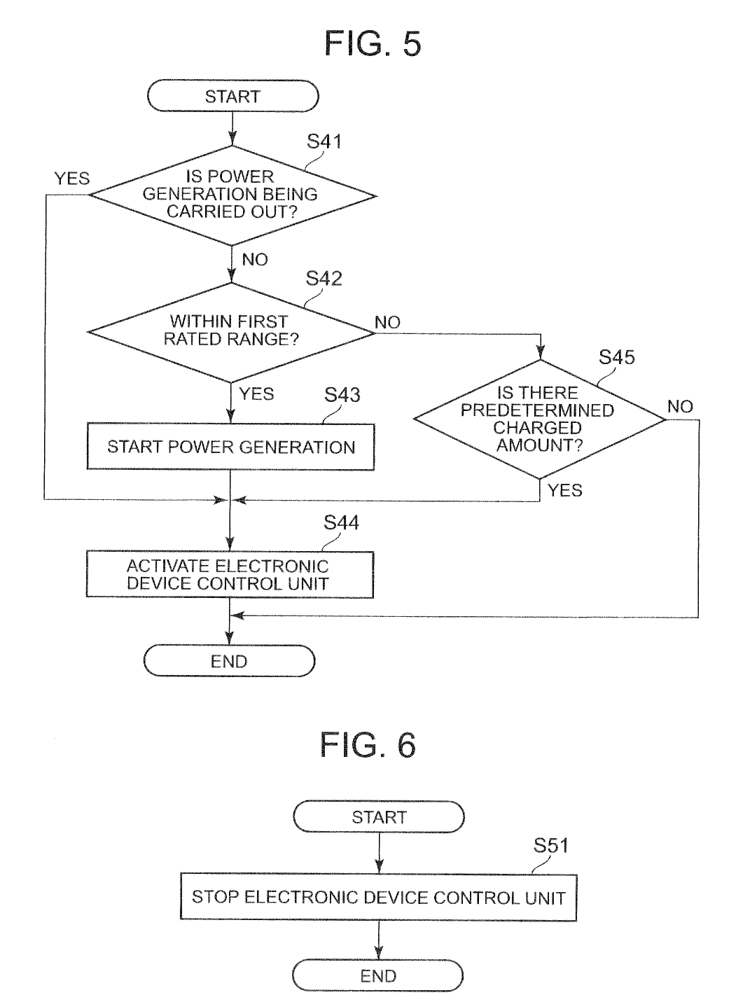

Independently from the processes shown in FIGS. 3 and 4, when the power on/off switch of the key input unit 35 is operated, the fuel cell control unit 31 interposes and carries out the process shown in FIG. 5. However, the process shown in FIG. 5 is executed by the fuel cell control unit 31 when the electronic device control unit 36 is not activated.

First, the fuel cell control unit 31 determines whether power generation is carried out in the fuel cell power generation unit 19 or not (step S41). The determination in step S41 is same as the determination of step S12.

When power generation is not carried out in the fuel cell power generation unit 19, the process of the fuel cell control unit 31 moves to step S42 (step S41: No). On the other hand, when power generation is carried out in the fuel cell power generation unit 19, the process of the fuel cell control unit 31 moves to step S44 (step S41: Yes).

In step S44, the fuel cell control unit 31 activates the electronic device control unit 36, and thereafter, the process of the fuel cell control unit 31 is finished. Then, the process shown in FIGS. 3 and 4 are carried out again picking up from where interrupted. Thereby, the power of the electronic device becomes in an on state.

In step S42, the fuel cell control unit 31 determines whether the environmental level detected by the first environmental level detection unit 50 is within the first rated range or not. The determination process of step S42 is same as the determination process of step S13. Therefore, detail description will be omitted.

As a result of the fuel cell control unit 31 comparing the environmental level detected by the first environmental level detection unit 50 to the upper limit value and lower limit value of the first rated range in step S42, when the environmental level detected by the first environmental level detection unit 50 is within the first rated range (step S42: Yes), the fuel cell control unit 31 drives the fuel supplier 12, the water supplier 16 and the air supplier 18 (step S43). Thereby, the fuel supplier 12, the water supplier 16 and the air supplier 18 are operated and power generation is carried out in the fuel cell power generation unit 19. Then, the fuel cell control unit 31 activates the electronic device control unit 36 (step S44) and the process of the fuel cell control unit 31 is finished, and then, the processes shown in FIGS. 3 and 4 are carried out again picking up from where interrupted. Thereby, the power of the electronic device becomes in an on state.

On the other hand, when the environmental level detected by the first environmental level detection unit 50 is not within the first rated range (step S42: No), the process of the fuel cell control unit 31 moves to step S45.

In step S45, the fuel cell control unit 31 determines whether the charged amount of the secondary cell 33 is greater than or equal to a predetermined value or not via the charging circuit 34. In particular, the fuel cell control unit 31 determines whether the voltage between terminals of the secondary cell 33 is greater than or equal to the predetermined threshold V1 or not. When the charged amount of the secondary cell 33 is greater than or equal to the predetermined value (step S45: Yes), that is, when the voltage between terminals of the secondary cell 33 is greater than or equal to the predetermined threshold V1, the fuel cell control unit 31 activates the electronic device control unit 36 (step S44) and the process of the fuel cell control unit 31 is finished, and then, the processes shown in FIGS. 3 and 4 are carried out again picking up from where interrupted. Thereby, the power of the electronic device becomes in an on state. On the other hand, when the charged amount of the secondary cell 33 is smaller than the predetermined value. (step S45: No), that is, when the voltage between terminals of the secondary cell 33 is greater than or equal to the predetermined threshold V1, the process of the fuel cell control unit 31 is finished and the processes shown in FIGS. 3 and 4 are carried out again picking up from where interrupted. Thereby, the power of the electronic device maintains to be in an off state.

Independently from the processes shown in FIGS. 3 and 4, when the power on/off switch of the key input unit 35 is operated, the fuel cell control unit 31 interposes and carries out the process shown in FIG. 6. However, the process shown in FIG. 6 is to be executed by the fuel cell control unit 31 when the electronic device control unit 36 is activated.

As shown in FIG. 6, when a user operates the power on/off switch, the fuel cell control unit 31 stops the electronic device control unit 36 (step S51). Then, the process of the fuel cell control unit 31 is finished and the processes shown in FIGS. 3 and 4 are carried out again picking up from where interrupted.

As described above, according to the embodiment, the power generation by the fuel cell power generation unit 19 is started only when the voltage between terminals of the secondary cell 33 is reduced to the predetermined threshold V1 in the normal environmental level (for example, room temperature) to make the charged amount of the secondary cell 33 be full (step S22, step S23 and step S25). Therefore, the number of times the power generation is started in order to charge the secondary cell 33 can be reduced.

Further, when the power generation by the fuel cell power generation unit 19 is started, a great amount of power is consumed until the fuel cell power generation unit 19 reaches the steady state. However, by reducing the number of times of the above described starting of power generation, the amount of fuel to be consumed in the fuel accumulation unit 11 can be made to be reduced.

Moreover, even when the voltage between terminals of the secondary cell 33 is greater than or equal to the predetermined threshold V1, the power generation of the fuel cell power generation unit 19 is started to charge the secondary cell 33 before the environmental level falls outside of the first rated range (for example, slightly before the water in the water accumulation unit 15 freezes and slightly before the fuel in the fuel accumulation unit 11 is likely to boil) (step S22, step S24 and step S25). Therefore, when there is a possibility that the environmental level falls outside of the first rated range (for example, when there is a possibility that water freezes and that fuel boils), the possibility that the voltage between terminals of the secondary cell 33 becomes smaller than V1 becomes low. Therefore, the possibility of not being able to operate the electronic device becomes low.

Similarly, when there is a possibility that the environmental level falls outside of the first rated range (for example, when there is a possibility that water freezes and that fuel boils), it is less likely that the voltage between terminals of the secondary cell 33 becomes smaller than the lower limit value VL. Therefore, a possibility that the power generation in the fuel cell power generation unit 19 cannot be started becomes low.

Moreover, at that time, the predetermined threshold V2 which is smaller than the upper limit value VF is used as a voltage larger than the predetermined threshold V1. Therefore, the consumption amount of the fuel in the fuel accumulation unit 11 can be reduced. This is because there is no need to repeat the power generation by the fuel cell power generation unit 19 every time the voltage between terminals of the secondary cell 33 becomes slightly lower than the upper limit value VF when compared to a case where the upper limit value VF which is used instead of the predetermined threshold V2.

When the voltage between terminals of the secondary cell 33 became smaller than the predetermined threshold V1 but when the environmental level is outside of the rated range (for example, when charging cannot be carried out due to a possibility of water freezing and fuel boiling (step S23: No)), thereafter, the environmental level is constantly monitored every minute and the power generation is started as soon as it is in a state where power can be generated to carry out the charging (step S20: Yes). Even in such case, it is less likely that the secondary cell 33 consumes power to a level where the power generation cannot be started in the fuel cell power generation unit 19. At this time, by carrying out the process every minute, the power consumption can be reduced comparing to the case where the process is carried out before 1 minute elapses.

### Second Embodiment

The structure of the fuel cell system 1 of the embodiment is same as that of the fuel cell system 1 of the first embodiment. Therefore, detail description will be omitted. Hereinafter, a flow of a process carried out by the fuel cell control unit 31 and an operation of the electronic device and the like will be described.

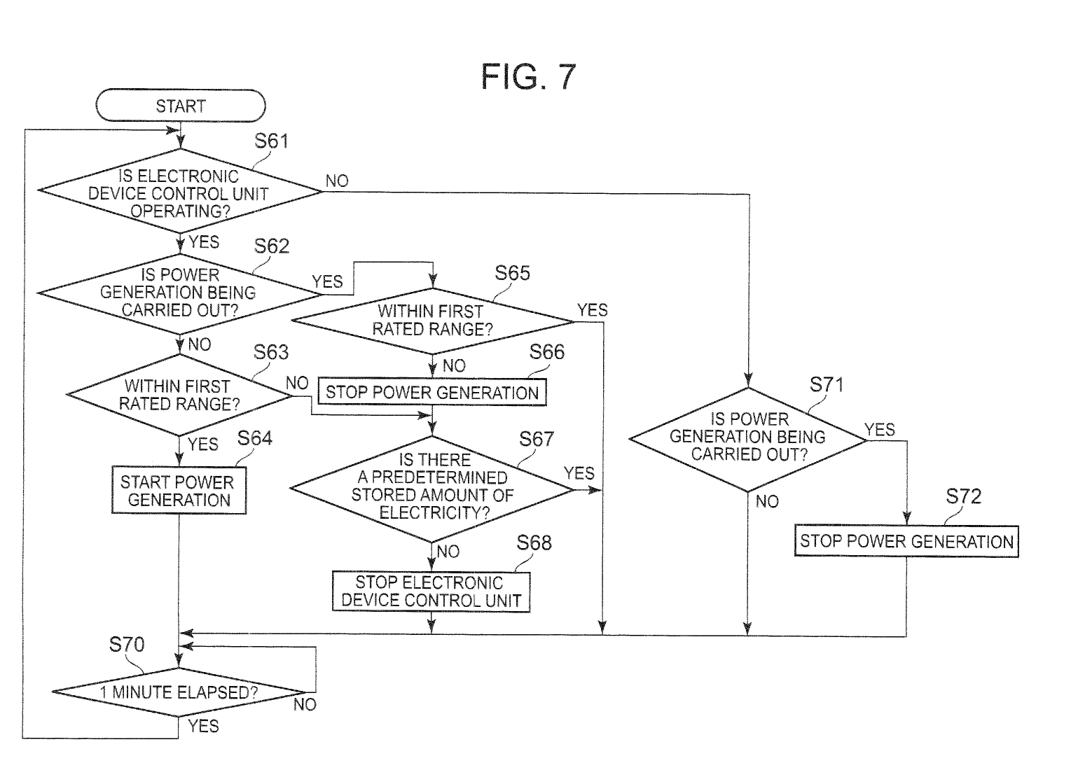

FIG. 7 is a diagram showing a flow of a process carried out by the fuel cell control unit 31. The fuel cell control unit 31 carries out the process shown in FIG. 7 regardless of whether the electronic device control unit 36 is activated or not. Among the processes shown in FIG. 7, the process which is carried out in a case where the electronic device control unit 36 is in an activated state, that is, step S61 and each process which is carried out when a signal indicating that the electronic device control unit 36 is in an activated state is inputted to the fuel cell control unit 31 from the electronic device control unit 36 (step S61: Yes) (steps S62 to S68 and S70) are same as step S11, the steps S12 to S18 and S20 of the first embodiment. Therefore, the detail description will be omitted.

On the other hand, when the electronic device control unit 36 is in a stopped state, the process of the fuel cell control unit 31 moves to step S71 because a signal indicating that the electronic device control unit 36 is in a stopped state is inputted to the fuel cell control unit 31 from the electronic device control unit 36 (step S61: No).

In step S71, the fuel cell control unit 31 determines whether power generation is carried out in the fuel cell power generation unit 19 or not. The determination process in step S71 is same as the determination process in step S12. Therefore, the detail description is omitted. When the fuel supplier 12, the water supplier 16 or the air supplier 18 is stopped, power generation is not carried out in the fuel cell power generation unit 19. Therefore, the process of the fuel cell control unit 31 moves to step S70 (step S71: No). In step S70, the fuel cell control unit 31 waits only for a predetermined time (for example, for a short period of time such as 1 minute) (step S70: No) and the process of the fuel cell control unit 31 returns to step S61 after the predetermined time elapses (step S70: Yes).

On the other hand, when the fuel supplier 12, the water supplier 16 and the air supplier 18 are operated, power generation is carried out in the fuel cell power generation unit 19. Therefore, the process of the fuel cell control unit 31 moves to step S72 (step S71: Yes) and the fuel cell control unit 31 stops the fuel supplier 12, the water supplier 16 and the air supplier 18 (step S16). Then, the process of the fuel cell control unit 31 moves to step S70. In step S70, the fuel cell control unit 31 waits only for a predetermined time (for example, for a short period of time such as 1 minute) (step S70: No) and the process of the fuel cell control unit 31 returns to step S61 after the predetermined time elapses (step S70: Yes).

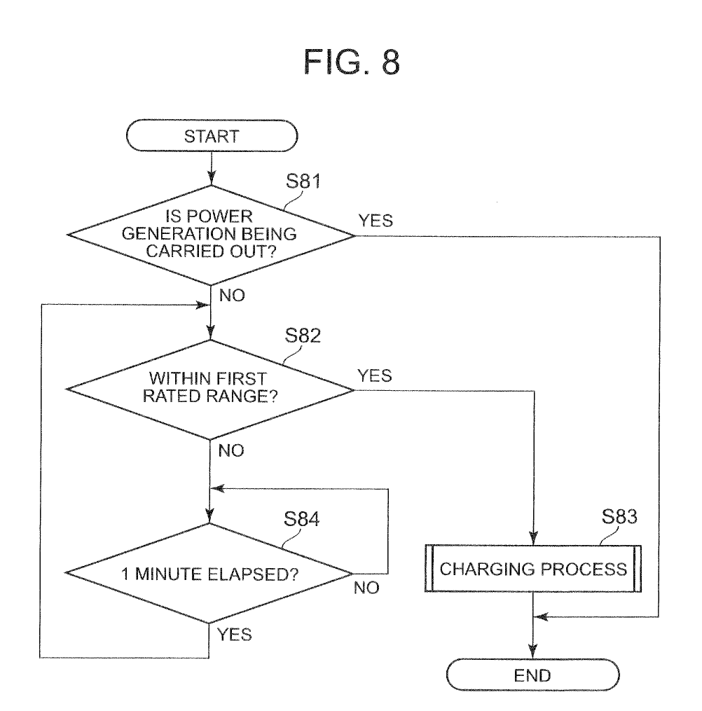

Independently from the process shown in FIG. 7, the fuel cell control unit 31 interposes and carries out the process shown in FIG. 8 once in 10 days.

First, the fuel cell control unit 31 determines whether power generation is carried out in the fuel cell power generation unit 19 or not (step S81). The determination in step S81 is same as the determination in step S12. When power generation is carried out in the fuel cell power generation unit 19 (step S81: Yes), the fuel cell control unit 31 finishes the process shown in FIG. 8 and carries out the process shown in FIG. 7 picking up from where interrupted.

When power generation is not carried out in the fuel cell power generation unit 19 (step S81: No), the fuel cell control unit 31 determines whether the environmental level detected by the first environmental level detection unit 50 is within the first rated range or not (step S82). The determination process in step S82 is same as the determination process in step S13. Therefore, detail description will be omitted.

As a result of the fuel cell control unit 31 comparing the environmental level detected by the first environmental level detection unit 50 to the upper limit value and lower limit value of the first rated range in step S82, when the environmental level detected by the first environmental level detection unit 50 is not within the first rated range (step S82: No), the process of the fuel cell control unit 31 moves to step S84. Then, the fuel cell control unit 31 waits only for a predetermined time (for example, for a short period of time such as 1 minute) (step S84: No) and the process of the fuel cell control unit 31 returns to step S82 after the predetermined time elapses (step S84: Yes).

As a result of the fuel cell control unit 31 comparing the environmental level detected by the first environmental level detection unit 50 to the upper limit value and lower limit value of the first rated range in step S82, when the environmental level detected by the first environmental level detection unit 50 is within the first rated range (step S82: Yes), the process of the fuel cell control unit 31 moves to step S83. The process in step S83 is same as the charging process of step S25, that is, same as the process shown in FIG. 4. Further, after step S83, the fuel cell control unit 31 finishes the process shown in FIG. 8 and carries out the process shown in FIG. 7 picking up from where interrupted.

As described above, according to the embodiment, when 10 days or more have passed since the day the charged amount of the secondary cell 33 was made to be full previously, there is a possibility that the charged amount of the secondary cell 33 is greatly reduced due to natural discharge and the like. Therefore, when the environmental level at present time is within the first rated range, the charging process is carried out (step S82 and step S83). Thereby, it is less likely that the electronic device cannot be operated.

### Third Embodiment

The structure of the fuel cell system 1 of the embodiment is same as that of the fuel cell system 1 of the first embodiment. Therefore, detail description is omitted. Hereinafter, a flow of a process carried out by the fuel cell control unit 31 and an operation of the electronic device and the like will be described.

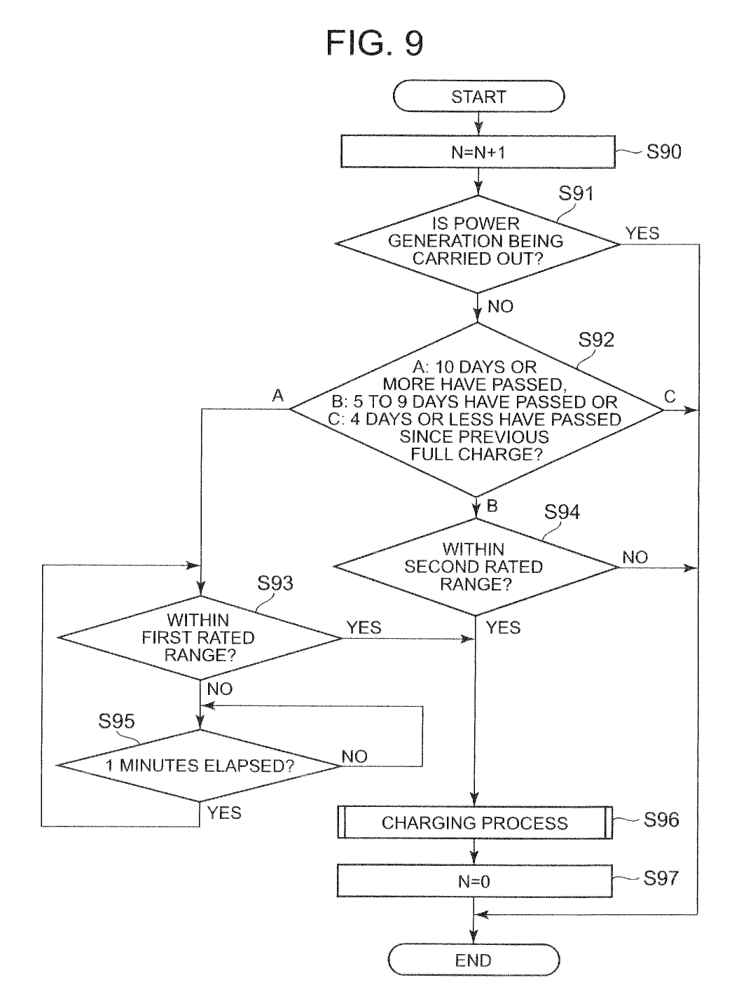

Also in the embodiment, the fuel cell control unit 31 carries out the process shown in FIG. 7. The process shown in FIG. 7 is same as the process in the second embodiment. Therefore, detail description will be omitted. Then, independently from the process shown in FIG. 7, the fuel cell control unit 31 interposes and carried out the process shown in FIG. 9 once in 24 hours.

First, the fuel cell control unit 31 adds 1 to a counter N which is stored in the storage unit 32 (step S90). Here, the counter N is a positive number and the counter N expresses the number of days because the process shown in FIG. 9 is carried out once in 24 hours. In particular, the counter N expresses the number of days passed since the day the charging process of step S96 was previously carried out, that is, the number of days since the day the charged amount of the secondary cell 33 was previously made to be full by the process of FIG. 9.

Then, the fuel cell control unit 31 determines whether power generation is carried out in the fuel cell power generation unit 19 or not (step S91). The determination in step S91 is same as the determination in step S12. When power generation is carried out in the fuel cell power generation unit 19 (step S91: Yes), the fuel cell control unit 31 finishes the process shown in FIG. 9 and carries out the process shown in FIG. 7 picking up from where interrupted.

First, the fuel cell control unit 31 compares the counter N stored in the storage unit 32 to the lower threshold (for example, 4) and to the upper threshold (for example, 10). In particular, the fuel cell control unit 31 determines whether the counter N is smaller than or equal to the lower threshold or not, whether the counter N is greater than the lower threshold and smaller than the upper threshold and whether the counter N is greater than or equal to the upper threshold or not.

When the counter N is greater than the lower threshold and smaller than the upper threshold (for example, when 5 to 9 days have passed since the day when the charged amount of the secondary cell 33 was previously made to be full; step S92; B), the process of the fuel cell control unit 31 moves to step S94. Further, when the counter N is greater than or equal to the upper threshold (for example, when 10 days or more have passed since the day when the charged amount of the secondary cell 33 is previously made to be full; step S92; A), the process of the fuel cell control unit 31 moves to step S93. Furthermore, when the counter N is greater than or equal to the upper threshold (for example, when 4 days or less has passed since the day when the charged amount of the secondary cell 33 was previously made to be full; step S92; C), the fuel cell control unit 31 finishes the process shown in FIG. 9 and carries out the process shown in FIG. 7 again picking up from where interrupted. In FIG. 9, step S93 or step S94 corresponds to the first determination process and the process of step S92 corresponds to the second determination process.

In step S93, the fuel cell control unit 31 determines whether the environmental level detected by the first environmental level detection unit 50 is within the first rated range or not (step S93). The determination process of step S93 is same as the determination process of step S13. Therefore, detail description will be omitted.

As a result of the fuel cell control unit 31 comparing the environmental level detected by the first environmental level detection unit 50 to the upper limit value and lower limit value of the first rated range in step S93, when the environmental level detected by the first environmental level detection unit 50 is not within the first rated range (step S93: No), the process of the fuel cell control unit 31 moves to step S95. Then, the fuel cell control unit 31 waits only for a predetermined time (for example, for a short period of time such as 1 minute) (step S95: No) and the process of the fuel cell control unit 31 returns to step S93 when the predetermined time elapses (step S95: Yes).

On the other hand, as a result of the fuel cell control unit 31 comparing the environmental level detected by the first environmental level detection unit 50 to the upper limit value and lower limit value of the first rated range in step S93, when the environmental level detected by the first environmental level detection unit 50 is within the first rated range (step S93: Yes), the process of the fuel cell control unit 31 moves to step S96. The process of step S96 is same as the charging process of step S25, that is, same as the process shown in FIG. 4, and thereby, the charged amount of the secondary cell 33 is made to be full. Then, after step S96, the fuel cell control unit 31 resets the counter N by setting the counter N to zero (step S97) and finishes the process shown in FIG. 9 and then, the fuel cell control unit 31 carries out the process shown in FIG. 7 again picking up from where interrupted.

In step S94, the fuel cell control unit 31 determines whether the environmental level detected by the first environmental level detection unit 50 is within the second rated range or not. The determination process in step S94 is same as the determination process in step S24. Therefore, detail description will be omitted.

As a result of the fuel cell control unit 31 comparing the environmental level detected by the first environmental level detection unit 50 to the upper limit value and lower limit value of the second rated range in step S94, when the environmental level detected by the first environmental level detection unit 50 is not within the second rated range (step S94: No), the process shown in FIG. 9 is finished. Then, the fuel cell control unit 31 carries out the process shown in FIG. 7 again picking up from where interrupted.

On the other hand, as a result of the fuel cell control unit 31 comparing the environmental level detected by the first environmental level detection unit 50 to the upper limit value and lower limit value of the second rated range in step S94, when the environmental level detected by the first environmental level detection unit 50 is within the second rated range (step S94: Yes), the process of the fuel cell control unit 31 moves to step S96. The process of step S96 is same as the charging process of step S25, that is, same as the process shown in FIG. 4, and thereby, the charged amount of the secondary cell 33 is made to be full. Then, after step S96, the fuel cell control unit 31 resets the counter N by setting the counter N to zero (step S97). Further, the fuel cell control unit 31 finishes the process shown in FIG. 9 and carries out the process shown in FIG. 7 again picking up from where interrupted.

Here, independently from the process shown in FIG. 7, the fuel cell control unit 31 may interpose and carry out the process shown in FIG. 9 at a time interval different from the above described embodiment such as once in 7 days or once in 6 hours, for example.

Moreover, the processing order of each process of step S92 to step S94 can be arbitrarily interchanged. Regardless of in which order the processes are carried out, the fuel cell control unit 31 carries out the charging process of step S96 only when the fuel cell control unit 31 determines that the following conditions are fulfilled, and thereafter, the process of the fuel cell control unit 31 moves to step S97.

That is, firstly, when it is determined that 10 days or more have passed since the day the charge capacity of the secondary cell 33 was previously made to be full in the second determination process of step S92 (step S92: A) and when it is determined that the environmental level detected by the first environmental level detection unit 50 is within the first rated range in the first determination process of step S93 (step S93: Yes), the fuel cell control unit 31 carries out the charging process of step S96, and thereafter, the process of the fuel cell control unit 31 moves to step S97. Further, secondly, when it is determined that 5 to 9 days have passed since the charged amount of the secondary cell 33 was previously made to be full in the second determination process of step S92 (step S92: B) and when it is determined that the environmental level detected by the second environmental level detection unit 50 is within the second rated range in the first determination process of step S94 (step S94 : Yes), the fuel cell control unit 31 carries out the charging process of step S96, and thereafter, the process of the fuel cell control unit 31 moves to step S97.

As described above, according to the embodiment, there is a possibility that the charged amount of the secondary cell 33 is greatly reduces due to natural discharge or the like when 10 days or more have passed since the day when the charged amount of the secondary cell 33 is previously made to be full. Therefore, the charging process is carried out when the present environmental level is within the first rated range (step S92, step S93, step S96). Thereby, the possibility that the electronic device cannot be operated is reduced.

Moreover, because there is a possibility that the charged amount of the secondary cell 33 has reduced for a certain amount due to natural discharge or the like when 5 to 9 days have passed since the day the charged amount of the secondary cell 22 is previously made to be full although the reduced amount is smaller comparing to the case when 10 days or more have passed. Therefore, the fuel cell control unit 31 carries out the charging process when the present environmental level is within the second rated range (step S92, step S94, step S96). Thereby, the possibility that the electronic device cannot be operated is reduced.

Furthermore, when 4 days or less have passed since the day that the charged amount of the secondary cell 33 was previously made to be full, the charged amount of the secondary cell 33 is reduced for a small amount due to natural discharge or the like. Thus, the charging process is not carried out (step S92: C).

In any case, the number of times the power generation is started for charging can be reduced.

### Modification Example 1

Hereinafter, a modification example will be described. In the above described first embodiment, the fuel cell control unit 31 determines whether the environmental level detected by the first environmental level detection unit 50 is within the second rated range or not in step S24 shown in FIG. 3. In contrast, in the modification example, the fuel cell control unit 31 determines whether any of the environmental levels in the environmental level record is within the second rated range or not.

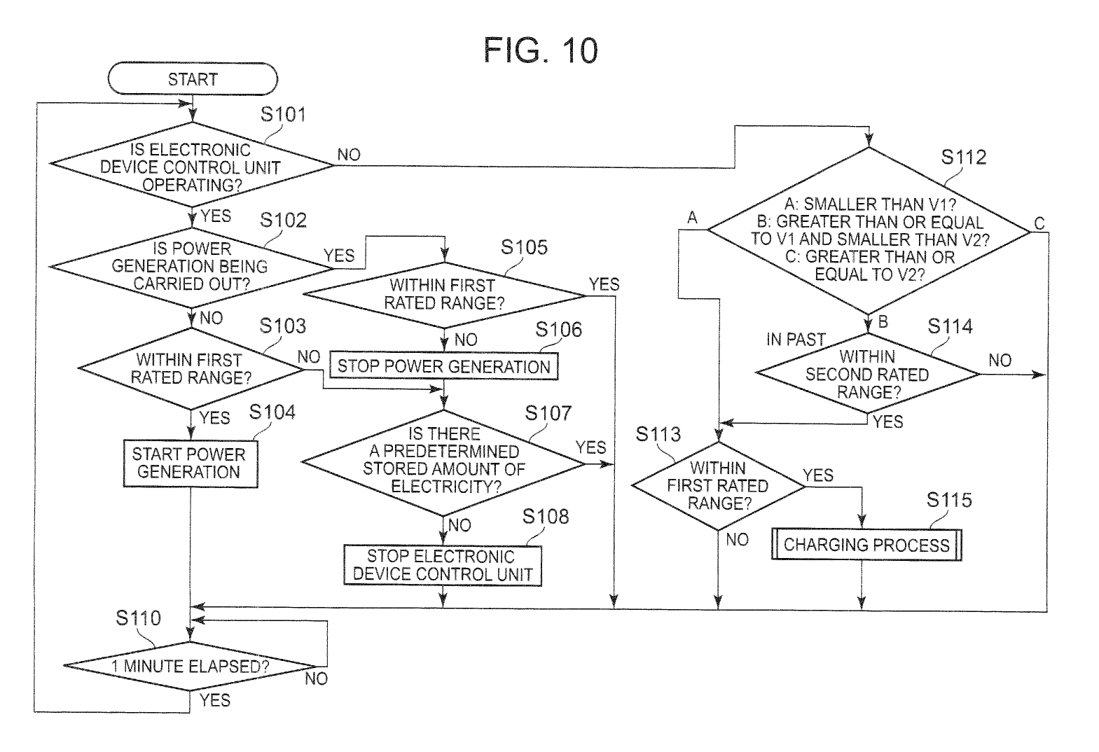

In order to realize the above, the fuel cell control unit 31 executes the process shown in FIG. 10 instead of the process shown in FIG. 3 in contrast to the first embodiment. Here, the process shown in FIG. 10 is different comparing to the process shown in FIG. 3 in that the process of step S114 shown in FIG. 10 is carried out instead of the process of step S24 shown in FIG. 3. Further, as described later, apart of the process shown in FIG. 4 which is the process of step S115 shown in FIG. 10 is different. Except for these differences, the modification example is same as the first embodiment. Therefore, detail description regarding the common processes will be omitted.

The fuel cell control unit 31 executes the following process concurrently with the processes shown in FIGS. 10 and 4. That is, the environmental level is detected by the first environmental level detection unit 50, then, the fuel cell control unit 31 records the environmental level detected by the first environmental level detection unit 50 in the storage unit 32 every predetermined time so as to correspond to the detected time when the signal expressing the detected environmental level is being outputted to the fuel cell control unit 31. Thereby, the data columns (accumulated environmental levels) of the detected environmental levels corresponded to the detected time are accumulated in the storage unit 32. Here, the fuel cell control unit 31 accumulates the detected environmental levels for the past predetermined period of time (for example, for one week) in the storage unit 32, and the detected environmental levels before the predetermined period of time may be deleted from the storage unit 32.

Then, in step S114, the fuel cell control unit 31 reads the data columns of the detected environmental levels recorded in the storage unit 32. Then, the fuel cell control unit 31 determines whether any of the data columns of the detected environmental levels which are read is within the second rated range or not (step S114). When there is at least one environmental level which is within the second rated range included in the data columns of the detected environmental levels of the past predetermined period of time which are read (step S114: Yes), the flag which indicates that at least one environmental level which is within the second rated range is included in the data columns of the detected environmental levels which are read is switched on. Then, the process of the fuel cell control unit 31 moves to step S113.

On the other hand, when there is no environmental level which is within the second rated range included in the data columns of the detected environmental levels for the past predetermined period of time which are read (step S14: No), the flag which indicates that at least one environmental level which is within the second rated range is included in the data columns of the detected environmental levels which is read is switched off. Then, the process of the fuel cell control unit 31 moves to step S110. Further, the fuel cell control unit 31 waits only for a predetermined time (for example, for a short period of time such as 1 minute) (step S110: No) and the process of the fuel cell control unit 31 returns to step S101 after the predetermined time elapses (step S110: Yes).

Moreover, in the modification example, the fuel cell control unit 31 carries out the process same as the process shown in FIG. 4 in the charging process of step S115. However, the process is different from the process shown in FIG. 4 in the following points. That is, in the modification example; the fuel cell control unit 31 reads the above described flag first in step S32. Then, when the above described flag is on, the fuel cell control unit 31 determines whether the voltage between terminals of the secondary cell 33 is greater than or equal to the predetermined threshold V3 or not instead of determining whether the voltage between terminals of the secondary cell 33 is greater than or equal to the upper limit value VF or not. Here, the relation between the predetermined threshold V1, the predetermined threshold V2, the predetermined threshold V3, the lower limit value VL and the upper limit value VF is VL<V1<V2<V3<VF. That is, only the particular values of thresholds are changed. On the other hand, when the above described flag is off, the process which is same as the process shown in FIG. 4 is to be carried out. Therefore, detail of the description will be omitted. In FIG. 10, the process of step S113 corresponds to the first determination process, the process of step S112 corresponds to the second determination process and the process of step S114 corresponds to the third determination process.

Moreover, the processing order of each process of step S112 to step S114 can be arbitrarily interchanged. Regardless of the order in which the processes are carried out, the fuel cell control unit 31 carries out the charging process of step S115 only when the fuel cell control unit 31 determines that the following conditions are fulfilled, and thereafter, the process of the fuel cell control unit 31 moves to step S110.

That is, firstly, when it is determined that the voltage between terminals of the secondary cell 33 is smaller than the predetermined threshold V1 in the second determination process of step S112 (step S112: A) and when it is determined that the environmental level detected by the first environmental level detection unit 50 is within the first rated range in the first determination process of step S113 (step S113: Yes) at the same time, the fuel cell control unit 31 carries out the charging process of step S115, and thereafter, the process of the fuel cell control unit 31 moves to step S110. Further, secondly, when it is determined that the charged amount of the secondary cell 33 is greater than or equal to the first predetermined value and smaller than the second predetermined value in the second determination process of step S112 (step S112: B), when it is determined that at least one of the accumulated environmental levels which are the data columns of the environmental levels detected by the environmental level detection unit 50 is within the second rated range in the third determination process of step S114 (step S114: Yes) and when it is determined that the environmental level detected by the second environmental level detection unit 50 is within the first rated range in the first determination process of step S114 (step S113: Yes) at the same time, the fuel cell control unit 31 carries out the charging process of step S25, and thereafter, the process of the fuel cell control unit 31 moves to step S20.

As described above, according to the modification example, when there is at least one environmental level (for example, room temperature) which is within the second rated range included in the past predetermined period of time, water and fuel cannot be supplied even when the power generation is needed to be carried out in near future (for example, within one week). Therefore, there is a possibility that power generation cannot be carried out in the fuel cell power generation unit 19. Thus, when the present environmental level is at a temperature in which power generation can be carried out in the fuel cell power generation unit 19, power generation is carried out (step S114, step S113, and step S115). Thereby, the possibility that the electronic device cannot be operated is reduced.

Moreover, when the voltage between terminals of the secondary cell 33 is greater than or equal to the predetermined threshold V1 and smaller than the predetermined threshold V2 and when there is at least one environmental level which is within the second rated range included in the data columns of the detected environmental levels of the past predetermined period of time which are read, the secondary cell 33 is only charged to the value of V3 which is a value smaller than the VF in the charging process (step S112, step S114, step S113, and step S115). Thereby, the amount of fuel in the fuel accumulation unit 11 to be consumed can be reduced.

### Modification Example 2

In the above described third embodiment, the fuel cell control unit 31 determines whether the environmental level detected by the first environmental level detection unit 50 is within the second rated range or not in step S94 shown in FIG. 9. In contrast, in the modification example, the fuel cell control unit 31 determines whether any of the environmental levels in the environmental level record is within the second rated range or not.

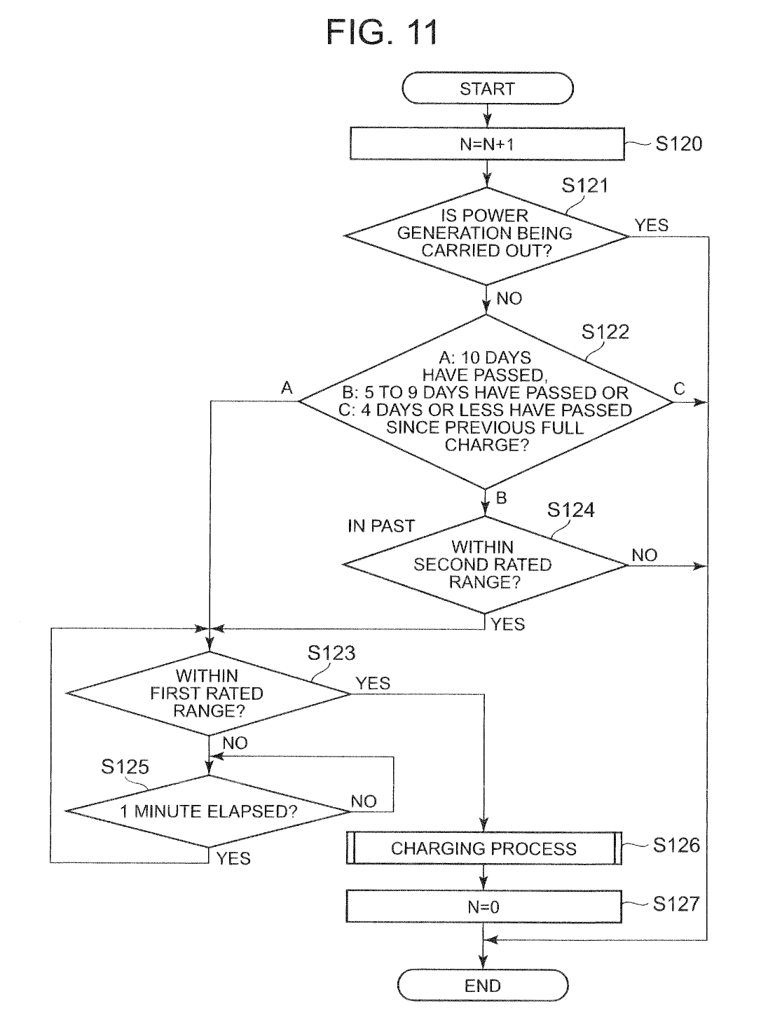

In order to realize the above, the fuel cell control unit 31 carries out the process shown in FIG. 7. The process shown in FIG. 7 is same as the process in the second embodiment. Therefore, detail description will be omitted. Further, independently from the process shown in FIG. 7, the fuel cell control unit 31 interposes and executes the process shown in FIG. 11 once in every 24 hours. Here, comparing to the process shown in FIG. 9, the process shown in FIG. 11 differs in the point that the process of step S124 shown in FIG. 11 is carried out instead of the process of step S94 shown in FIG. 9. Further, as described later, a part of the process shown in FIG. 4 which is the process of step S126 shown in FIG. 11 is different. Except for the above points, the modification example is same as the third embodiment. Therefore, detail description regarding the common process will be omitted.

Similarly to the above described modification example 1, the fuel cell control unit 31 executed the following process concurrently with the processes shown in FIGS. 11, 7 and 4. That is, the environmental level is detected by the first environmental level detection unit 50, and the fuel cell control unit 31 records the environmental levels detected by the first environmental level detection unit 50 in the storage unit 32 every predetermined time so as to correspond the to detected time while the signal expressing the detected environmental level is outputted to the fuel cell control unit 31. Thereby, the data columns (accumulated environmental levels) of the detected environmental levels which are corresponded to the detected time are accumulated in the storage unit 32. Here, the fuel cell control unit 31 accumulates the detected environmental levels of the past predetermined period of time (for example, for one week) in the storage unit 32, and the fuel cell control unit 31 may delete the detected environmental levels prior to the predetermined period of time from the storage unit 32.

Then, in step S124, the fuel cell control unit 31 reads the data columns of the detected environmental levels recorded in the storage unit 32. Further, the fuel cell control unit 31 determines whether any of the data columns of the detected environmental levels which are read is within the second rated range or not (step S124). When there is at least one environmental level which is within the second rated range included in the data columns of the detected environmental levels of the past predetermined period of time which are read (step S124: Yes), the flag which indicates that at least one environmental level which is within the second rated range is included in the data columns of the detected environmental levels which are read is switched on. Then, the process of the fuel cell control unit 31 moves to step S123.

On the other hand, when there is no environmental level which is within the second rated range included in the data columns of the detected environmental levels of the past predetermined period of time which are read (step S124: No), the flag which indicates that at least one environmental level which is within the second rated range is included in the data columns of the detected environmental levels which are read is switched off. Then, the process shown in FIG. 11 is finished and then, the fuel cell control unit 31 carries out the process shown in FIG. 7 again picking up from where interrupted.

Moreover, in the modification example, the fuel cell control unit 31 carries out the process similar to the process shown in FIG. 4 in the charging process of step S126. However, the process differs from the process shown in FIG. 4 in the following points. That is, in the modification example, the fuel cell control unit 31 first reads the above described flag in step S32. Then, when the above described flag is on, the fuel cell control unit 31 does not determine whether the voltage between terminals of the secondary cell 33 is greater than or equal to the upper limit value VF or not but determines whether the voltage between terminals of the secondary cell 33 is greater than or equal to the predetermined threshold V3 or not. Here, the relationship between the predetermined threshold V1, the predetermined threshold V2, the predetermined threshold V3, the lower limit value VL and the upper limit value VF is VL<V1<V2<V3<VF. That is, only the particular threshold values are changed. On the other hand, when the above described flag is off, the process same as the process shown in FIG. 4 is carried out. Therefore, detail description will be omitted. In FIG. 11, step S123 corresponds to the first determination process, step S122 corresponds to the second determination process and step S124 corresponds to the third determination process.

Moreover, the processing order of each process of step S122 to step S124 can be arbitrarily interchanged. Regardless of the order in which the processes are carried out, the fuel cell control unit 31 carries out the charging process of step S126 only when the fuel cell control unit 31 determines that the following conditions are fulfilled, and thereafter, the process of the fuel cell control unit 31 moves to step S127.

That is, firstly, when it is determined that 10 days or more have passed since the day the charged amount of the secondary cell 33 is previously made to be full in the second determination process of step S122 (step S122: A) and when it is determined that the environmental level detected by the first environmental level detection unit 50 is within the first rated range in the first determination process of step S123 (step S123: Yes) at the same time, the fuel cell control unit 31 carries out the charging process of step S126, and thereafter, the process of the fuel cell control unit 31 moves to step S127. Further, secondly, when it is determined that 5 to 9 days have passed since the day the charged amount of the secondary cell 33 was previously made to be full in the second determination process of step S122 (step S122: B), when it is determined that at least one of the accumulated environmental levels which are the data columns of the environmental levels detected by the secondary environmental level detection unit 50 is within the second rated range in the third determination process of step S124 (step S124: Yes) and when it is determined that the environmental level detected by the second environmental level detection unit 50 is within the first rated range in the first determination process of step S124 (step S123: Yes) at the same time, the fuel cell control unit 31 carries out the charging process of step S126, and thereafter, the process of the fuel cell control unit 31 moves to step S127.

As described above, according to the modification example, the charging process is carried out when the present environmental level is within the first rated range because there is a possibility that the charged amount of the secondary cell 33 is greatly reduced due to natural discharge or the like when 10 days or more have passed since the day the charged amount of the secondary cell 33 is previously made to be full (step S122, step S123 and step S126). Thereby, the possibility that the electronic device cannot be operated is reduced.

Moreover, when 5 to 9 days have passed since the day the charged amount of the secondary cell 33 was previously made to be full, there is a possibility that the charged amount of the secondary cell 33 is reduced for an amount less than when 10 days or more have passed due to natural discharge or the like. Therefore, the fuel cell control unit 31 determines whether any of the past environmental levels is within the second rated range or not. Then, when at least one of the past environmental levels is within the second rated range, the fuel cell control unit 31 determines whether the present environmental level is within the first rated range or not. When the present environmental level is within the first rated range, the charging process is carried out (step S122, step S124, step S123 and step S126). Thereby, the possibility that the electronic device cannot be operated is reduced.

Further, when 4 days or less have passed since the day the charged amount of the secondary cell 33 was previously made to be full, the amount reduced in the charged amount of the secondary cell 33 due to natural discharge or the like is small. Therefore, the charging process is not carried out (step S122: C).

In any case, number of times of carrying out power generation for charging can be reduced.

Moreover, when there is at least one environmental level (for example, room temperature) which is within the second rated range included in the past predetermined period of time, water and fuel cannot be supplied even when power generation is needed in the near future (for example, within one week). Therefore, there is a possibility that power generation cannot be carried out in the fuel cell power generation unit 19. Thus, when the present environmental level is at a temperature in which power generation can be carried out in the fuel cell power generation unit 19, power generation is carried out (step S124, step S123 and step S126). Thereby, the possibility that the electronic device cannot be operated is reduced.

Furthermore, when 5 to 9 days have passed since the day the charged amount of the secondary cell 33 was previously made to be full and when there is at least one environmental level which is within the second rated range included in the data columns of the detected environmental levels of the past predetermined period of time which are read, the secondary cell 33 is only charged to the value V3 which is a value smaller than the VF in the charging process (step S122, step S124, step S123 and step S126). Thereby, the amount of fuel in the fuel accumulation unit 11 to be consumed can be reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claim and their equivalents.

What is claimed is:

1. A fuel cell system, comprising:
a secondary cell;
a fuel cell power generation unit to carry out a power generation by an electrochemical reaction between a fuel and a water;
a supply unit to supply the fuel and the water to the fuel cell power generation unit;
a charging circuit to charge an electric energy generated in the fuel cell power generation unit to the secondary cell;
an environmental level detection unit to detect an environmental level; and
a fuel cell control unit to control the supply unit based on the environmental level detected by the environmental level detection unit.

2. The fuel cell system according to claim 1, wherein
the fuel cell control unit carries out a first determination process to determine whether the detected environmental level is within a first rated range or not, and
the fuel cell control unit carries out a charging process to operate the supply unit when the detected environmental level is determined as being within the first rated range by the first determination process.

3. The fuel cell system according to claim 2, wherein the fuel cell control unit carries out the first determination process again after a predetermined time elapses when the detected environmental level is determined as not being within the first rated range by the first determination process.

4. The fuel cell system according to claim 2, wherein the fuel cell control unit detects a charged amount of the secondary cell, and sets the first rated range to be used in the first determination process based on the detected charged amount of the secondary cell when the fuel cell control unit determines to carry out the first determination process based on the detected charged amount.

5. The fuel cell system according to claim 2, wherein the fuel cell control unit detects a charged amount of the secondary cell, and carries out a second determination process to determine whether the detected charged amount is within a predetermined range or not, and
the fuel cell control unit carries out a charging process to operate the supply unit when the detected environmental level is determined as being within the first rated range by the first determination process and when the detected charged amount is determined as being within the predetermined range by the second determination process.

6. The fuel cell system according to claim 5, wherein
the fuel cell control unit carries out the second determination process again after a predetermined time elapses when the detected environmental level is determined as being within the first rated range by the first determination process and when the detected charged amount is determined as not being within the predetermined range by the second determination process.

7. The fuel cell system according to claim 4, wherein
the fuel cell control unit detects a voltage between terminals of the secondary cell as the charged amount of the secondary cell.

8. The fuel cell system according to claim 5, wherein
the fuel cell control unit detects a voltage between terminals of the secondary cell as the charged amount of the secondary cell.

9. The fuel cell system according to claim 2, wherein
the fuel cell control unit measures an elapsed time since the charging process is executed, and carries out a second determination process to determine whether the elapsed time is within a predetermined range or not, and
the fuel cell control unit carries out the charging process to operate the supply unit when the detected environmental level is determined as being within the first rated range by the first determination process and when the elapsed time is determined as being within the predetermined range by the second determination process.

10. The fuel cell system according to claim 2, wherein
the fuel cell control unit measures an elapsed time since the charging process is executed, and sets the first rated range to be used in the first determination process based on the elapsed time when the fuel cell control unit determines to carry out the first determination process based on the elapsed time.

11. The fuel cell system according to claim 1, further comprising a storage unit to read and write, wherein
the fuel cell control unit carries out an accumulation process to accumulate the detected environmental levels in the storage unit,
a reading process to read the accumulated environmental levels which are data columns of the detected environmental levels in a past predetermined period of time stored in the storage unit,
a determination process to determine whether any of the accumulated environmental levels read by the reading process is within a second rated range or not, and
a charging process to operate the supply unit when at least one of the accumulated environmental levels is determined as being within the second rated range by the determination process.

12. The fuel cell system according to claim 2, further comprising a storage unit to read and write, wherein
the fuel cell control unit carries out an accumulation process to accumulate the detected environmental levels in the storage unit,
a reading process to read the accumulated environmental levels which are data columns of the detected environmental levels in a paste predetermined period of time which is stored in the storage unit,
a third determination process to determine whether any of the accumulated environmental levels read by the reading process is within a second rated range or not, and
a charging process to operate the supply unit when the detected environmental levels is determined as being within the first rated range by the first determination process and when at least one of the accumulated environmental levels is determined as being within the second rated range by the third determination process.

13. The fuel cell system according to claim 12, wherein
the fuel cell control unit carries out a second determination process in which a charged amount of the secondary cell is detected to determine whether the detected charged amount is within a predetermined range or not, and
the charging process to operate the supply unit when the detected environmental levels is determined as being within the first rated range by the first determination process, when at least one of the accumulated environmental levels is determined as being within the second rated range by the third determination process and when the detected charged amount is determined as being within the predetermined range by the second determination process.

14. The fuel cell system according to claim 12, wherein
the fuel cell control unit carries out a second determination process in which an elapsed time since the charging process is executed is measured to determine whether the elapsed time is within a predetermined range or not, and
the charging process to operate the supply unit when the detected environmental level is determined as being within the first rated range by the first determination process, when at least one of the accumulated environmental levels is determined as being within the second rated range by the third determination process and when the elapsed time is determined as being within the predetermined range by the second determination process.

15. The fuel cell system according to claim 2, wherein
the environmental level is a temperature, the environmental level detection unit is a temperature sensor and the first rated range is a range between a temperature exceeding a freezing point of a water and a temperature lower than a boiling point of a fuel.

16. The fuel cell system according to claim 15, further comprising an atmospheric pressure sensor to detect an atmospheric pressure, and
the fuel cell control unit sets the first rated range to a range between a temperature exceeding a freezing point of the water according to the atmospheric pressure and a temperature lower than a boiling point of the fuel according to the atmospheric pressure.

17. The fuel cell system according to claim 1, further comprising an electronic device control unit to control an electronic device in which the fuel cell system is embedded, wherein
the fuel cell control unit controls the supply unit when the electronic device control unit is in a stopped state.
